(19) United States
(12) Patent Application Publication
(10) Pub. No.: US 2003/0058087 A1
(43) Pub. Date: Mar. 27, 2003

(54) Electronic ignition control box and fault monitoring system for a trench roller

(76) Inventors: Francis W. Wenzel, Fairport, NY (US); Gary A. Schwenck, Brighton, NY (US); Mark A. Corio, Rochester, NY (US)

Correspondence Address: JACOBSON HOLMAN PLLC, 400 SEVENTH STREET N.W., SUITE 600, WASHINGTON, DC, 20004, US

(21) Appl. No.: 09/769,355

(22) Filed: Jan. 26, 2001

(51) Int. Cl. B60Q 1/00

(52) U.S. Cl. 340/438; 340/425.5

(57) ABSTRACT

An electronic control ignition (ECI) box for use with a trench roller or other construction-type equipment to control engine operation and the distribution of electrical power to various components, monitor machine failure faults and engine operating parameters, and archive hours of use. Faults, operating parameters and hours are displayed to an operator using a microprocessor-controlled display. The entire ECI is embedded in a suitable thermally-conductive epoxy encapsulent to form a unitary component that is both vibration-resistant and weatherproof.

### BACKGROUND OF THE INVENTION

1. Field of the Invention

The present invention is related to the field of construction equipment and, more particularly, to an electronic control system for manual as well as remote control of construction equipment such as a trench roller, the electronic control system including an integrated display and acting as a fault monitoring system for providing information pertaining to equipment operation to an operator.

2. Description of the Related Art

Trench rollers are used to compact soil during a wide range of construction projects, including soil compaction of roadside trenches in the construction of roads and highways. The environmental conditions for a typical construction project are harsh, with the trench rollers often operating in trenches having a depth in excess of ten feet in which the banks are vulnerable to caving in and showering or burying the equipment with dirt and mud. In addition to exposure to unstable surrounding materials during operation, the trench roller is thereafter cleaned with a high-pressure washer, subjecting the mechanical parts thereof to further environmental stress.

Traditionally, control components are housed in a metal box containing terminal strips into which discrete relays are plugged. Most, if not all, of the wiring is susceptible to damage due to exposure to the aforementioned environmental factors including dust and moisture inherent to trench roller operation and maintenance. As a result, trench roller performance and reliability have been significantly degraded.

In addition to the stress of operational surroundings, the trench roller is inherently prone to break down due to the nature of its own operation. Compacting soil with forces of 13,000 pounds or more, with or without additional vibration, trench rollers may experience a range of operating malfunctions that result in engine shut-down of the machine. In the existing trench rollers, there is no way of knowing which of a range of possible problems was responsible for an engine shut-down. Resulting machine down-time as an operator or mechanic attempted to troubleshoot the problem by navigating the morass of often contaminated wiring represented considerable lost production time and wasted man-hours.

Accordingly, there is a need for a system that is both impervious to environmental factors and which allows for rapid diagnosis of engine faults in order to minimize machine down-time and optimize equipment operability.

### SUMMARY OF THE INVENTION

In order to overcome the problems encountered in the prior art, the present invention is directed to an electronic control ignition (ECI) box for use with a trench roller or other construction-type equipment. Using circuit board construction and a microprocessor programmed with software to interpret feedback devices and react accordingly, the ECI box controls engine operation and the distribution of electrical power to various components. The ECI box also monitors engine failure faults and operating parameters, and archives hours of use. Faults, operating parameters and hours are displayed on an associated LED display. The entire ECI is then encapsulated in a suitable plastic material to form a unitary component that is both vibration-resistant and weatherproof. The ECI box may be manually or remotely controlled.

In view of the foregoing, one object of the present invention is an electronic control ignition (ECI) box that provides the operator with electronic readouts of engine operating parameters, machine failure faults and hours of machine use using an embedded LED display.

Another object of the present invention is a microprocessor driven solid-state circuit board design for an ECI box that is resistant to vibration and the environment, being encapsulated in a polymeric material to form a weatherproof control “brick”.

A further object of the present invention is an ECI box for construction-type equipment that controls and routes power to and from devices on the machine being controlled.

A still further object of the present invention is an ECI box that enables a trench roller to be operated both manually and by radio frequency remote control, with simple transition from one operational mode to the other.

Another object of the present invention is a trench roller with improved component reliability due to environmental shielding, and reduced down-time through the ready availability of system feedback information.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of a trench roller with control panel and LED display in accordance with the present invention;

FIG. 2 is a front view of the control panel and LED display on the trench roller of FIG. 1;

FIG. 3 is an exploded view of the hood assembly incorporating the control panel and LED display of FIG. 2;

FIG. 4 is a perspective view of the ECI box mounted under the hood of the trench roller of FIG. 1;

FIG. 5 is a top view of a remote operator control transmitter handset for use with the trench roller of FIG. 1;

FIG. 6 is an exploded view of the remote assembly for operation of the trench roller using the remote operator control transmitter handset of FIG. 5;

FIG. 7A is a schematic drawing depicting the ECI box system interface, in accordance with the present invention;

FIG. 7B is a schematic drawing illustrating the electrical circuitry of the ECI box, in accordance with the present invention;

FIG. 8 is a schematic drawing of the controller circuit of FIG. 7B;

FIG. 9 is a schematic drawing of the display circuit of FIG. 7B;

FIG. 10 is a schematic drawing of the input signal conditioning circuits of FIG. 7B;

FIG. 11 is a schematic drawing of the power supply circuit of FIG. 7B;

FIG. 12 is a schematic drawing of the first solenoid driver circuit of FIG. 7B;

FIG. 13 is a schematic drawing of the second solenoid driver circuit of FIG. 7B;

FIG. 14 is a schematic drawing of the third solenoid driver circuit of FIG. 7B;

FIG. 15 is a flowchart of the initialization routine for the ECI box, in accordance with the present invention;

FIGS. 16A-16K are a flowchart of the INT routine for the ECI box, in accordance with the present invention;

FIG. 17A is a flowchart of the save_fault_data routine for the ECI box, in accordance with the present invention;

FIG. 17B is a flowchart of the restore_fault_data routine for the ECI box, in accordance with the present invention;

FIG. 18 is a flowchart of the restore_fault_byte routine for the ECI box, in accordance with the present invention;

FIG. 19 is a flowchart of the save_fault_byte routine for the ECI box, in accordance with the present invention;

FIG. 20 is a flowchart of the display_warning_message routine for the ECI box, in accordance with the present invention;

FIG. 21 is a flowchart of the get_battery_voltage routine for the ECI box, in accordance with the present invention;

FIG. 22 is a flowchart of the save_settings routine for the ECI box, in accordance with the present invention;

FIG. 23 is a flowchart of the restore_settings routine for the ECI box, in accordance with the present invention;

FIG. 24 is a flowchart of the display_voltage routine for the ECI box, in accordance with the present invention;

FIG. 25 is a flowchart of the display_run_time_hours routine for the ECI box, in accordance with the present invention;

FIG. 26 is a flowchart of the display_RPM_number routine for the ECI box, in accordance with the present invention;

FIG. 27 is a flowchart of the display_message routine for the ECI box, in accordance with the present invention; and

FIGS. 28A-28L are a flowchart of the main program for the ECI box, in accordance with the present invention.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings.

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

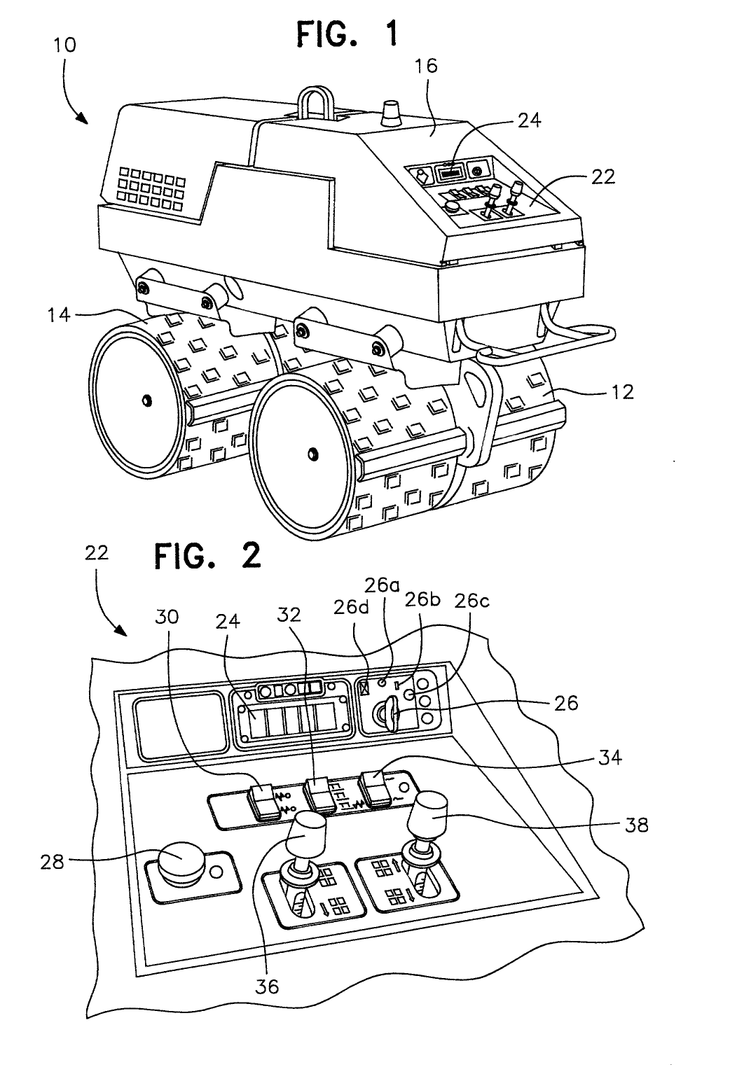

FIG. 1 is a perspective view of a trench roller equipped with an ECI box in accordance with the present invention. The trench roller, generally designated by the reference numeral 10, includes conventional components, except for the ECI box and LED display, and can be of standard known construction. As disclosed, the trench roller 10 has left drums 12, right drums 14, a hood 16, and a control panel, generally designated by the reference numeral 22, with an LED display 24.

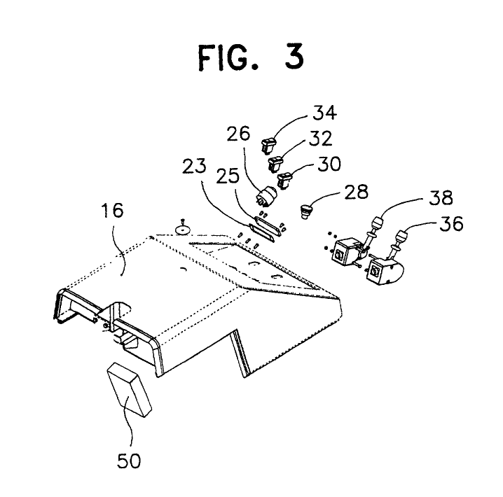

The control panel 22 with LED display 24 is shown in greater detail in FIG. 2, and in an exploded view in FIG. 3. More specifically, the control panel 22 includes a keyswitch 26 having an OFF position 26a, a RUN position 26b, an engine START position 26c, and an accessory position 26d, described later in detail. The control panel 22 further includes an emergency stop (E-Stop) button 28, a vibration direction switch 30, a vibration on/speed switch 32, an engine throttle switch 34, a left side forward/reverse control lever 36, and a right side forward/reverse control lever 38. The vibration direction switch 30, vibration on/speed switch 32, and the engine throttle switch 34 may be embodied as rocker switches.

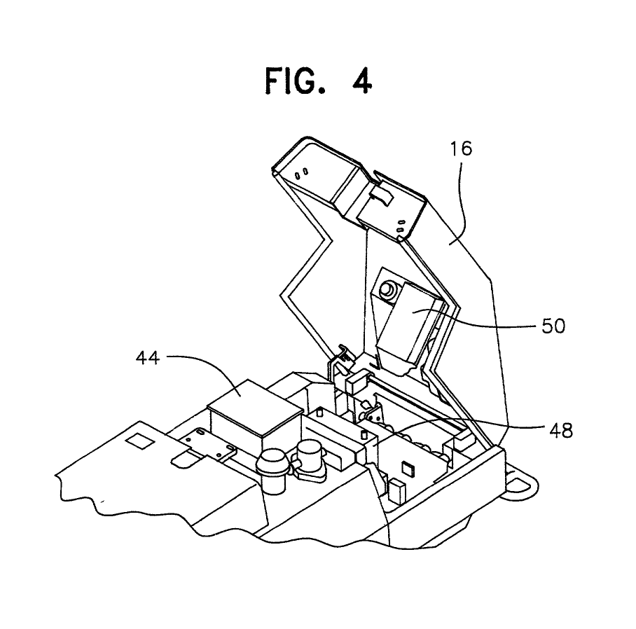

As shown in FIG. 3, the LED display 24 is covered by a clear window 25 secured to the front of the control panel 22 in any suitable manner such as a gasket 23. The ECI box 50 is rigidly mounted under the hood 16 and positioned so that the LED display 24 is viewable through the window 25 in the control panel 22. FIG. 4 is a perspective view of the ECI box 50 mounted rigidly beneath the hood 16, with the hood 16 shown in the open position. The ECI box 50 is rigidly mounted in position underneath the hood 16 by any suitable attaching mechanism.

During manual operation of the trench roller, the operator controls drum operation on the left and right sides of the trench roller with left and right side forward/reverse control levers 36, 38, respectively. If vibration is desired, the vibration shaft direction is selectable using the vibration direction switch 30, and vibration is turned on and the speed adjusted using the vibration on/speed switch 32. The engine throttle switch 34 is adjustable between idle speed and run speed.

As described above, the LED display 24 is located on the control panel 22. This LED display is preferably embedded into the ECI box 50 and is controlled through the microprocessor. The display's main function is to provide specific machine-operating information to the operator or to a mechanic who is accessing information about operation of the trench roller. By providing a read-out of the particular problem encountered, the display in conjunction with the ECI box represents a valuable improvement over the prior art. Rather than having to begin a troubleshooting sequence with no idea as to the basis of the problem, while associated work crews stand idle, the ECI box and display of the present invention greatly reduces engine down-time with the assistance of machine self-diagnosis through on-board sensors and related circuitry.

The LED display 24 preferably has the capability to display five categories of messages and information. These categories are presented through various displays including those presented while the engine is running, which can include the normal display as well as warnings; the display during engine start-up; and display values when the engine is not running. The display of values when the engine is not running includes a display of the hour meter and fault messages.

During engine start-up, while the keyswitch 26 is in the START position 26c, the battery voltage level is shown on the display 24. Once the engine has started and the keyswitch 26 has been rotated to the RUN position 26b, engine RPM is shown on the display 24. Engine RPM constitutes the normal display while the engine is running, and represents a valuable output for performance evaluation. More particularly, RPM may be used to evaluate the performance and efficacy of other machine systems, such as impact force, which are dependent on the maintenance of an appropriate RPM for their optimal effectiveness.

When the engine is running, with the keyswitch 26 in the RUN position 26b, the LED display 24 may display warning messages regarding engine or battery trouble during machine operation. Warnings are defined as messages that indicate the electrical system is not charging properly and are flashed on the display intermittently with RPM when the machine is running in the manual mode. Warning messages may include, among others, a voltage regulator low message (V Reg L) when the system is not charging properly; and a battery low message (Bat Low) when the voltage level of the battery is low. In a preferred embodiment, the Bat Low message is displayed at 10 volts.

When the engine is not running, the keyswitch may be moved to the accessory position 26d. In the accessory position 26d, the LED display 24 will show three different pieces of information, namely the hour meter, a fault message and the software revision level. The hour meter monitors machine run time and reflects the number of hours of operation. The fault message shows the last fault that occurred, and the software revision level indicates the revision level of the software that is controlling the microprocessor. This information is stored in non-volatile memory such that, in the event electrical power is lost, this information will remain intact and will again be available for display when electrical power has been reestablished.

A fault is defined as a situation that causes the machine/engine to shut down or to not start. Such engine shut-down may be initiated by engine protect circuits or machine protect devices. The fault messages are associated with particular faults and are shown on the display to indicate what is happening within the machine. As such, fault messages are very helpful during troubleshooting or when performing preventive maintenance.

Fault messages may include communications indicating one or more of the following, among others:

| Fault Message | Condition Initiating Display |
|---|---|
| low oil or no oil | proper oil pressure cannot be |
| | achieved and maintained |
| cylinder temperature | motor cylinder heads exceed |
| | safe operating temperature |
| tilt | machine tip angle has been |
| | exceeded |
| emergency stop | emergency stop button has been |
| (E-stop) | depressed and has not been |
| | reset |
| RPM low | engine speed has dropped |
| | below a minimum speed |

Various sensors may be used to monitor the fault conditions. In a preferred embodiment oil pressure is monitored by an oil pressure switch, motor cylinder temperature is monitored by a head temperature switch, trench roller tilt is monitored by a tip switch, emergency stop is monitored by the emergency stop button, and low RPM is monitored by the machine alternator output.

In the event of a fault, the engine will either refuse to start or will cease running. To view the fault message or messages, the keyswitch is turned to the accessory position 26d. There is always a fault message in the display when the keyswitch 26 is turned to the accessory position 26d. Therefore, the last fault message will be displayed even after the fault has been corrected. The fault messages are also stored in non-volatile memory.

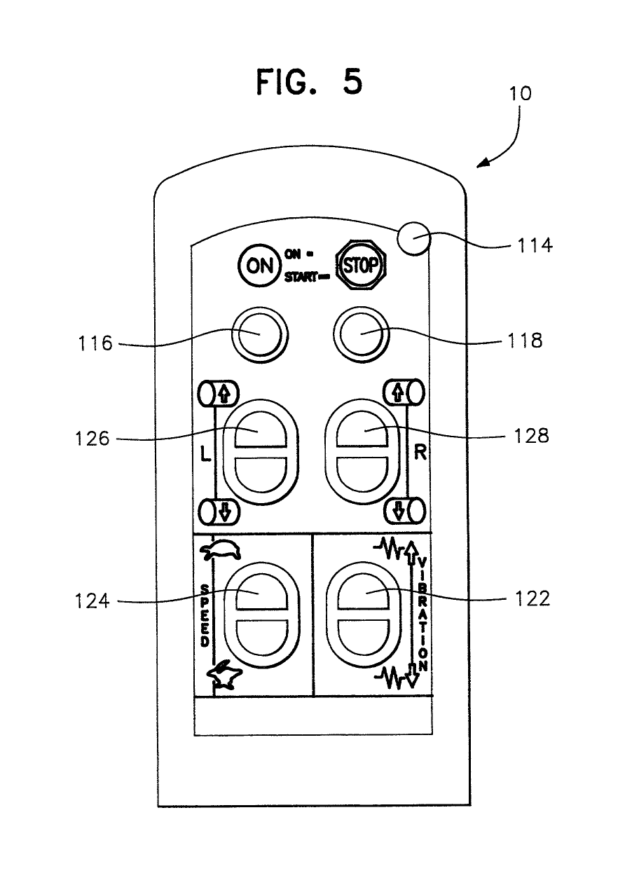

The trench roller 10 may be manually controlled through the control panel 22 or may be remotely controlled using a remote operator control transmitter handset, generally designated by the reference numeral 40, and shown in FIG. 5. The remote operator control transmitter handset 40 preferably includes the following: a power-on indicator 114, indicating when the transmitter handset is on; an ON/start button 116 for starting the engine in the remotely-located machine; a stop button 118 for stopping the engine of the remotely-located machine; a left side forward/reverse button 126, for controlling operation of the left drums 12; a right side forward/reverse button 128, for controlling operation of the right drums 14; a vibration ON/direction button 122, for turning vibration on and for controlling the direction of vibration; and a high/low speed button 124 for controlling engine speed and for shutting off vibration. In a preferred embodiment, switching engine speed to low also shuts off vibration.

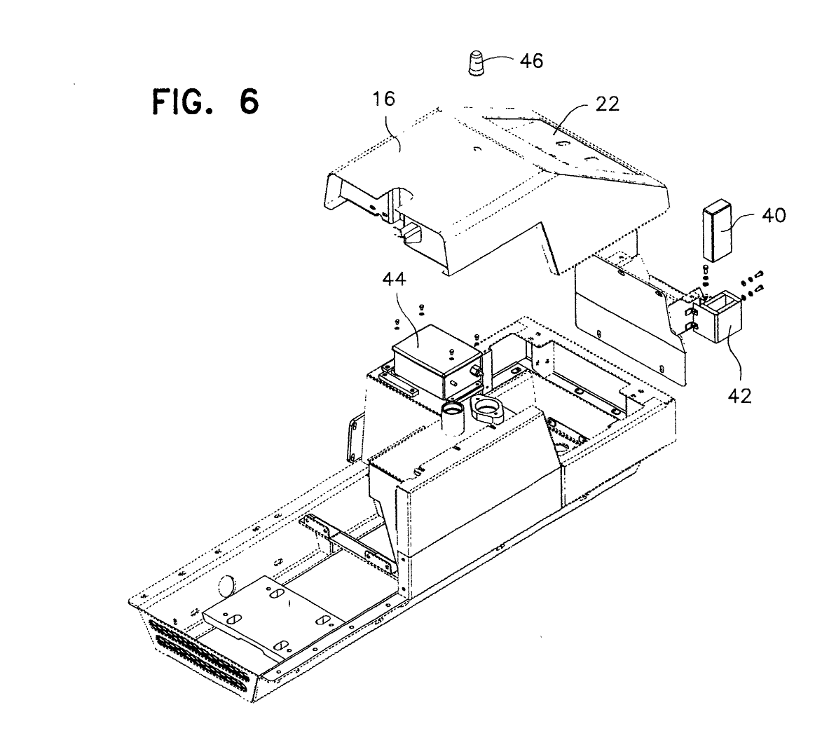

When operating in the remote mode, machine functions are manipulated through radio frequency (RF) control of a remote assembly. FIG. 6 shows an exploded view of the remote assembly for the trench roller 10. The remote assembly includes the transmitter handset 40, a receiver 44, and an antenna 46.

In FIG. 6, the transmitter handset 40 is shown as fitting into a transmitter box 42 for convenient storage. During remotely-controlled operation, however, the transmitter handset 40 would, of course, be located remotely from the transmitter box 42. Information is transmitted from the transmitter handset 40 to the receiver antenna 46. The antenna 46 directs the transmission to the receiver 44, conveniently mounted on the roller 10 such as under the hood 16 (see FIG. 4, where it is decoded and used to manipulate relays and switches which control engine and machine functions.

Signal transmission may be checked at the transmitter and at the receiver independently. At the transmitter, the power-on indicator 114 is preferably an LED window on the face of the transmitter handset 40. When the window is lit, glowing red in color and pulsing slowly, this indicates that the transmitter is on and functioning properly. When control buttons are depressed, the pulse rate in the window quickens. If the window color is amber, this indicates that the battery power of the transmitter is low and the batteries should be replaced. If the window fails to light, this indicates that the batteries are depleted and should be replaced.

The receiver 44 includes circuit boards having a series of LED lamps. These lamps light up when the receiver receives a signal from the transmitter to perform a function. Failure of the lamps to light indicates that the remote assembly is not functioning properly.

In a preferred embodiment, both the transmitter handset 40 and the receiver 44 are battery-powered. The transmitter preferably requires two AA 1.5 volt alkaline batteries, and the receiver is powered by a 12-volt machine battery 48. The receiver 44 is initialized through the accessory position 26d of the keyswitch 26.

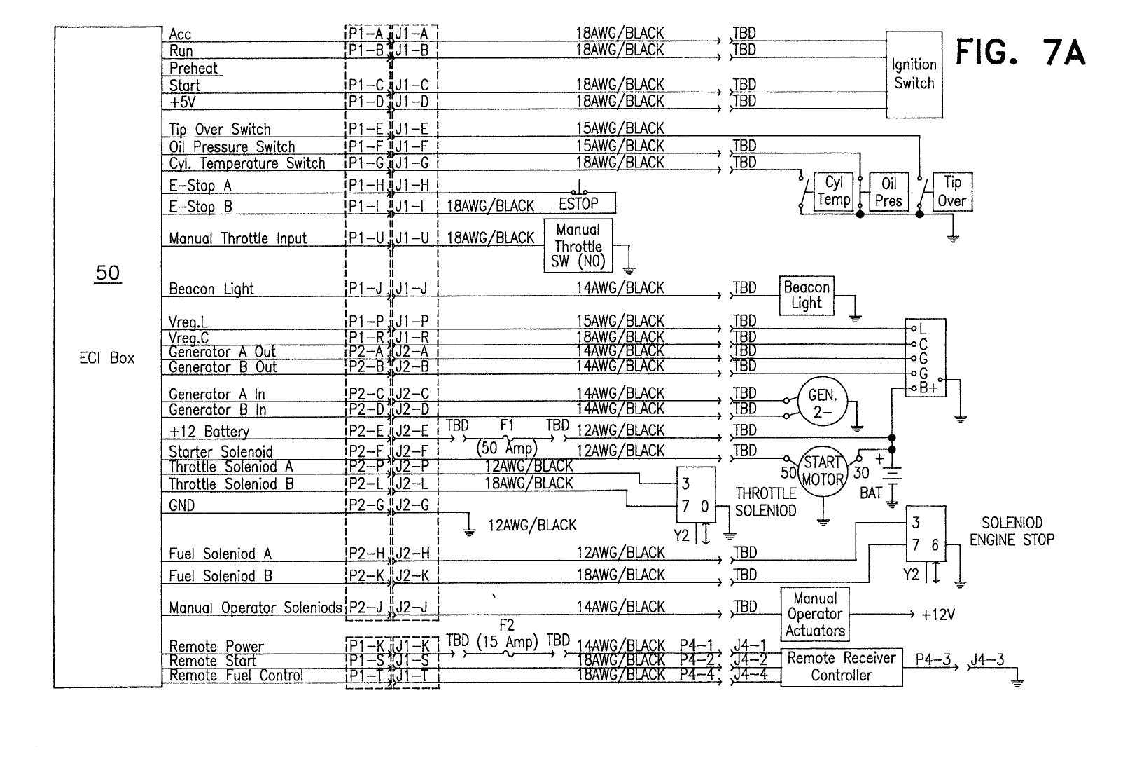

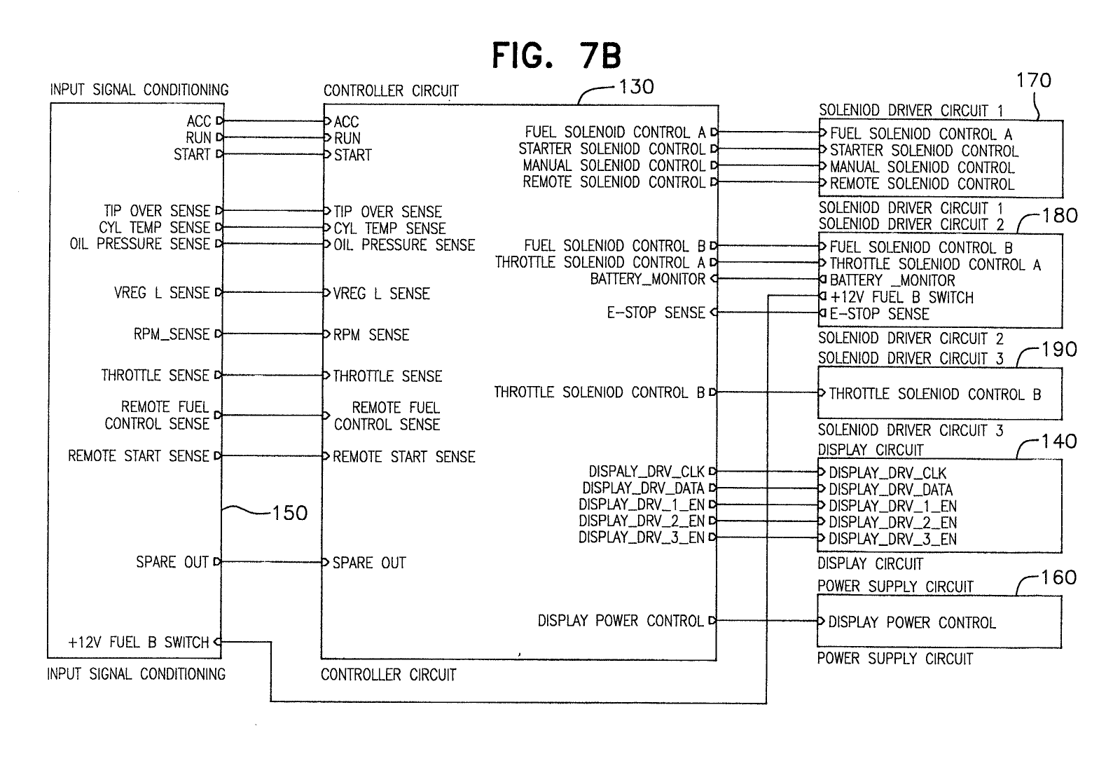

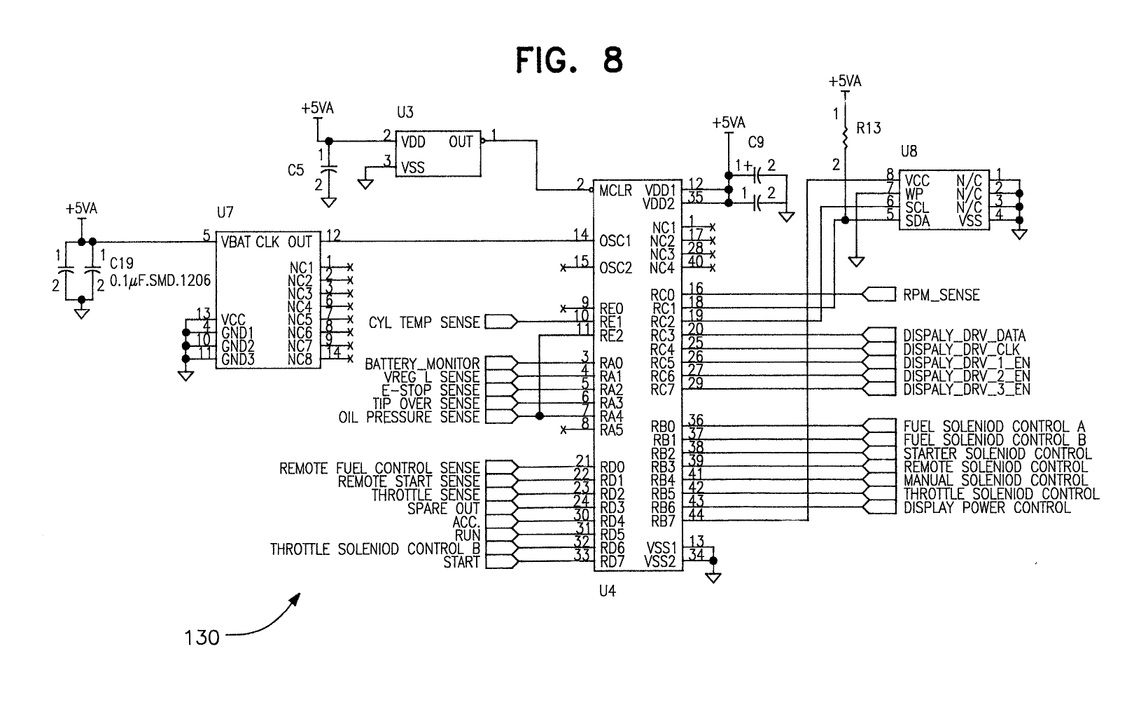

FIG. 7A depicts the system concept for the ECI box and fault monitoring system in accordance with the present invention. As shown, the ECI box 50 receives inputs from and directs outputs to a plurality of sensors and other devices. The ECI box includes the necessary interfaces to control both manual and remote operation of the trench roller.

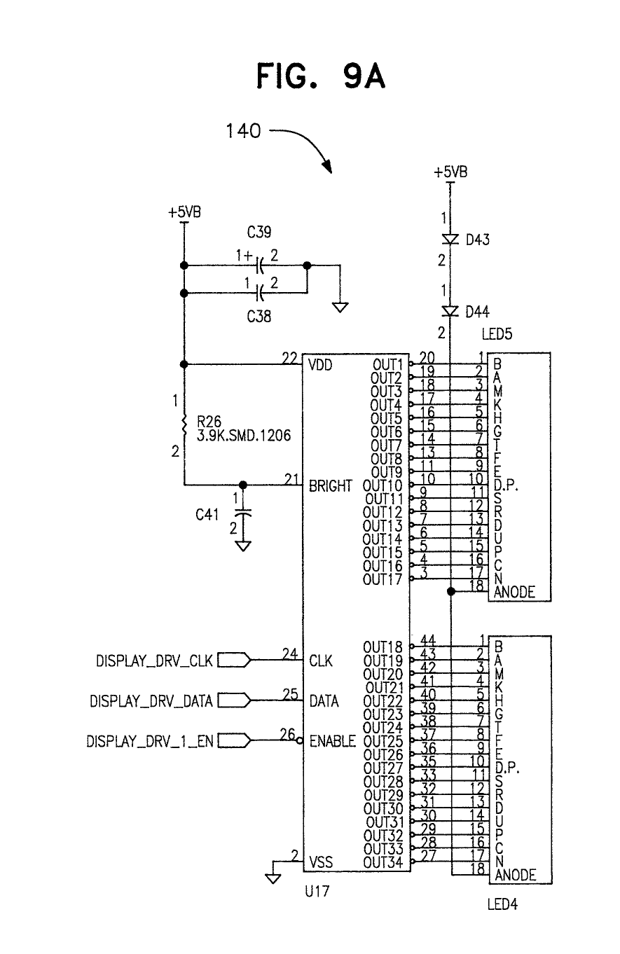

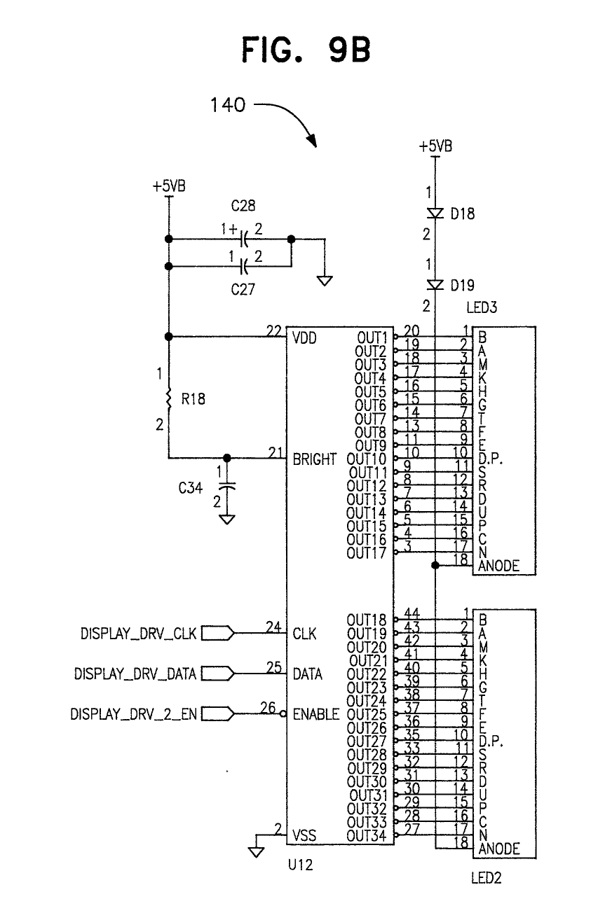

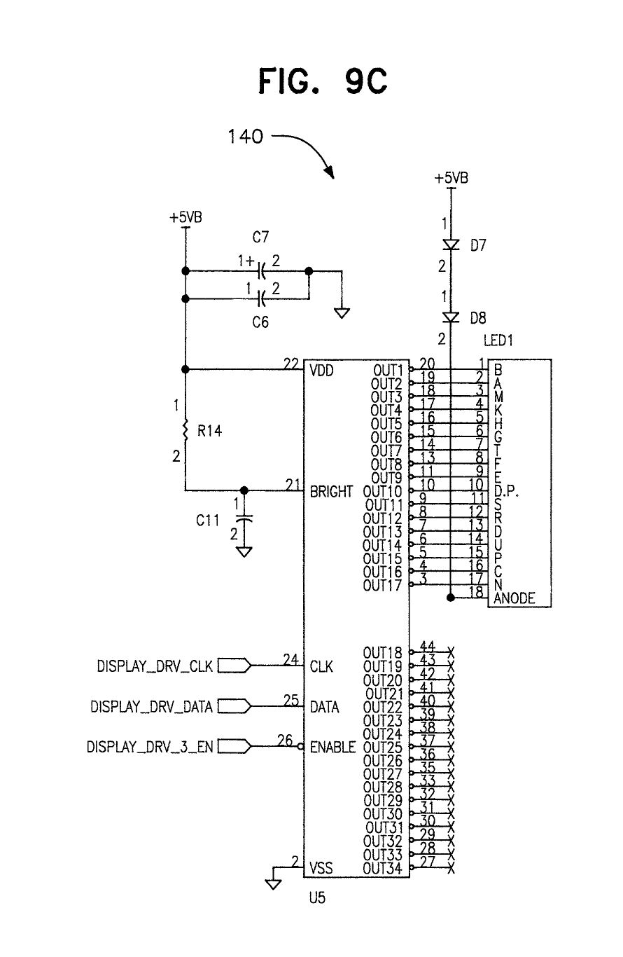

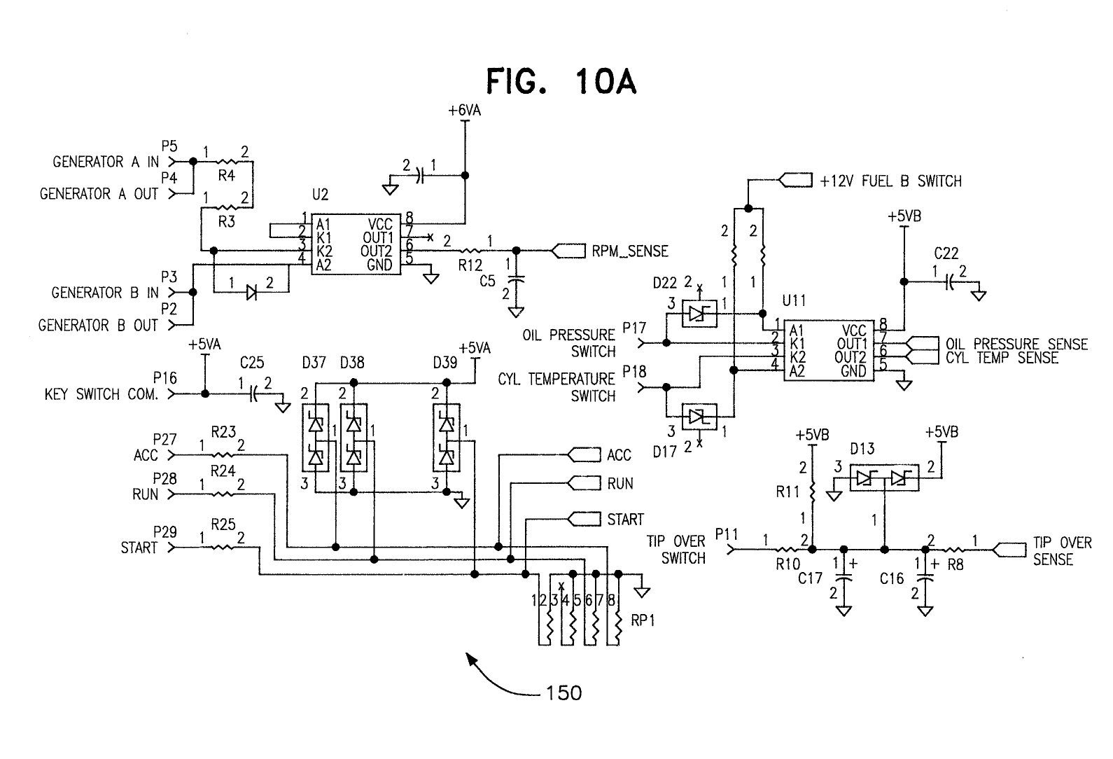

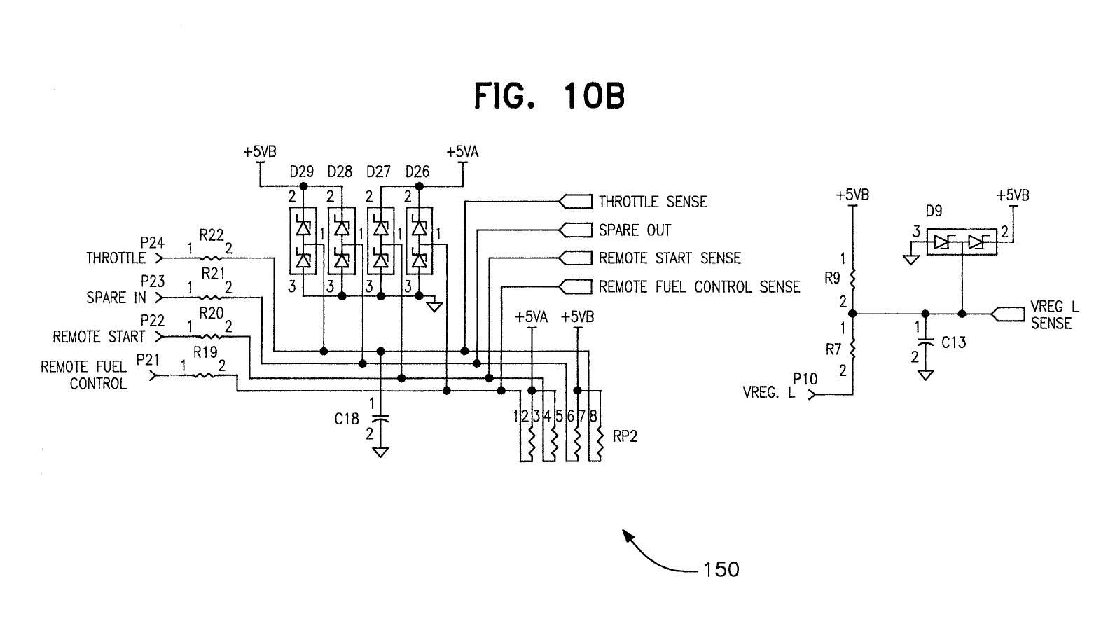

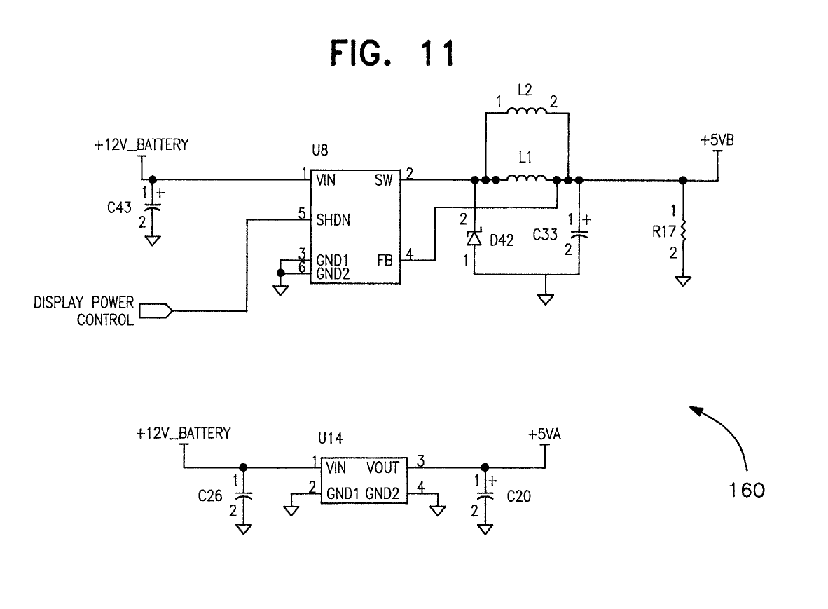

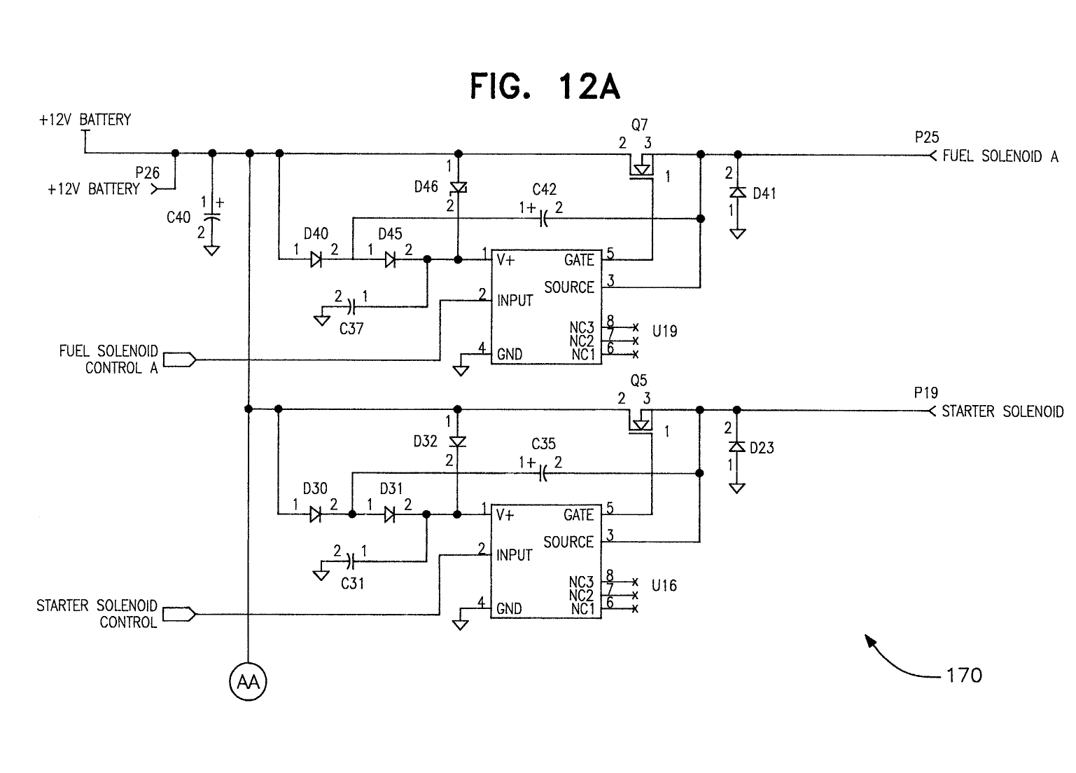

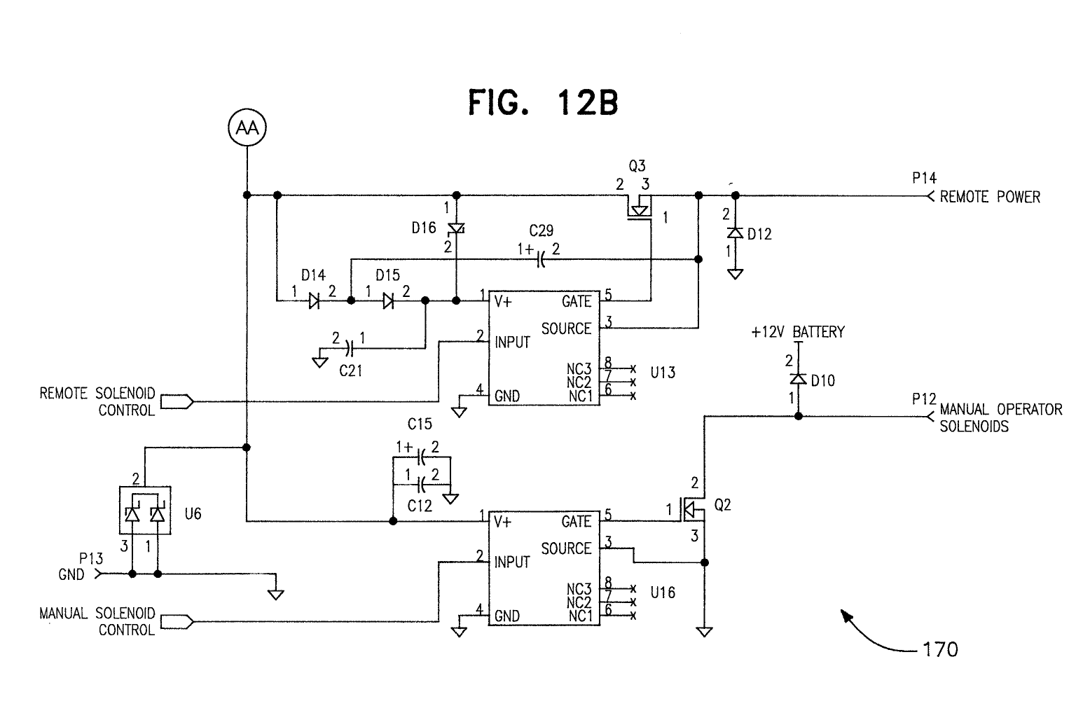

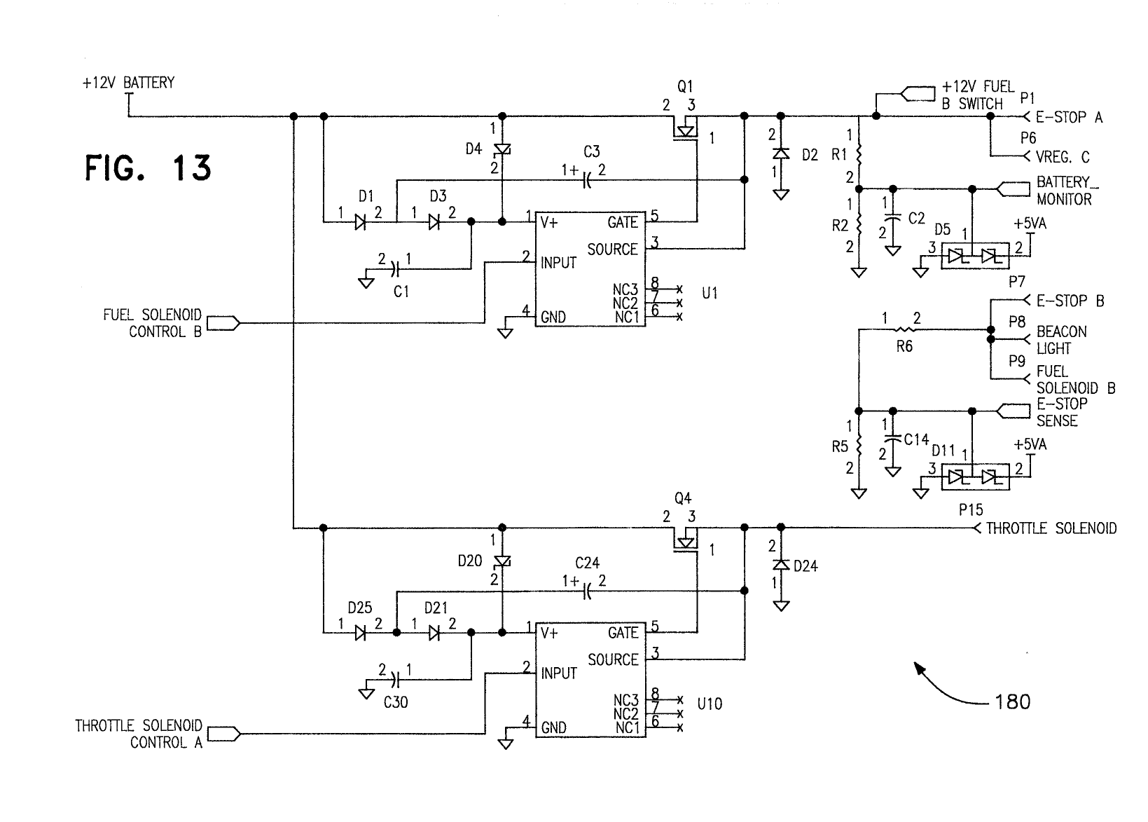

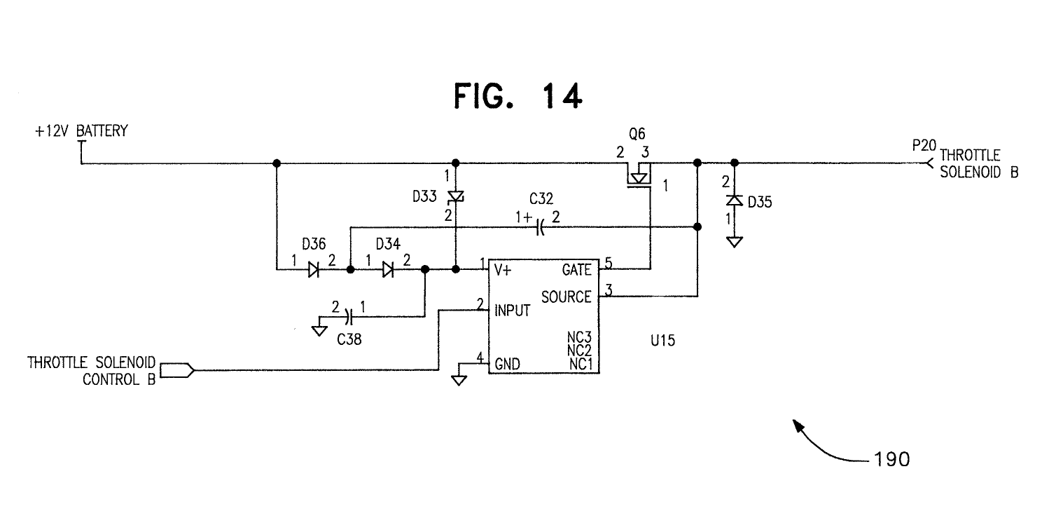

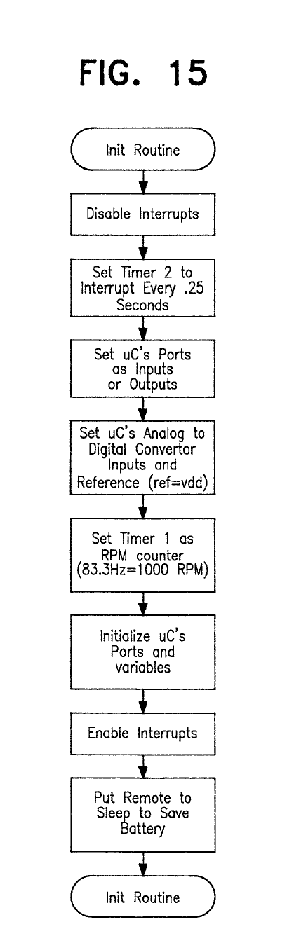

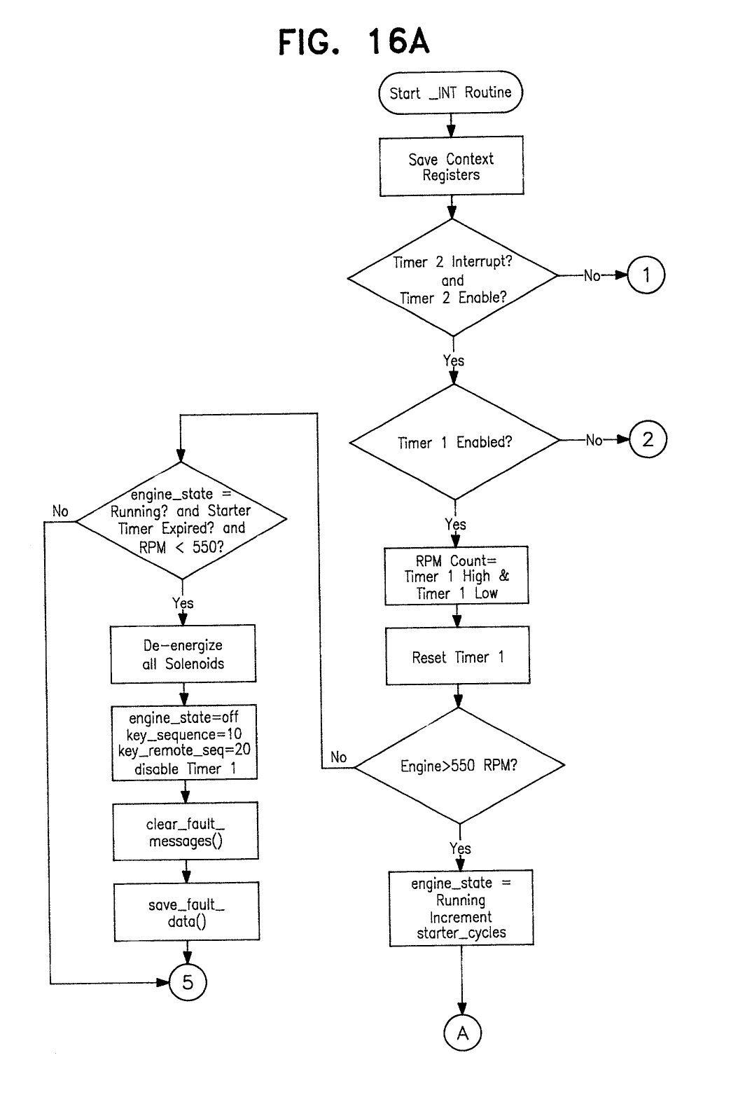

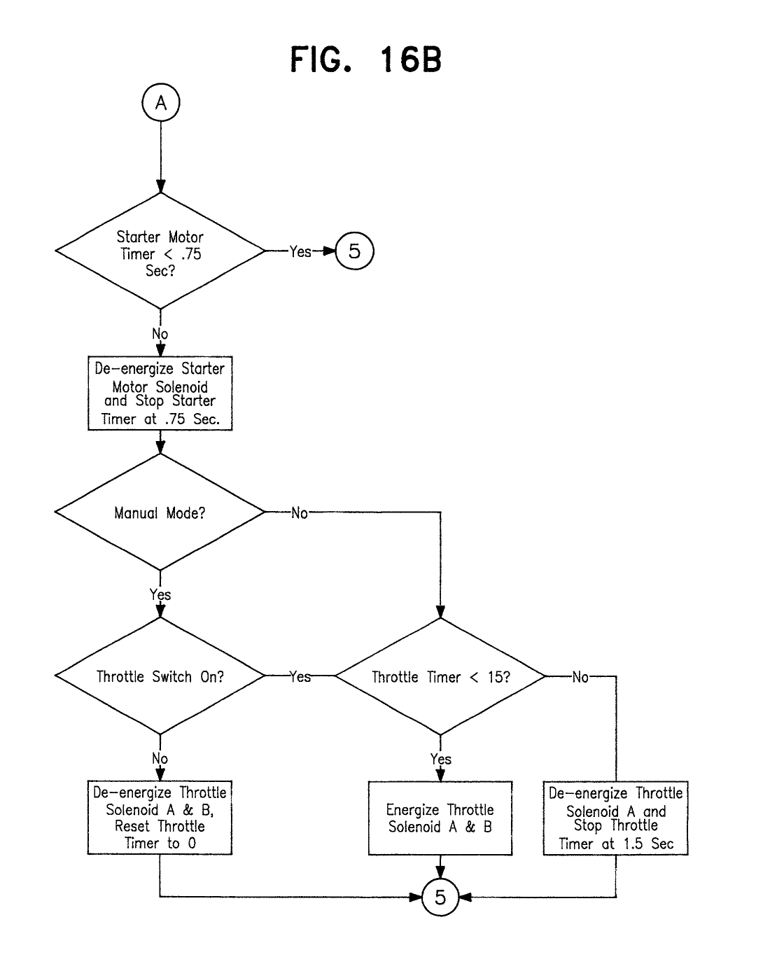

FIG. 7B is a schematic drawing illustrating the electrical circuitry of the ECI box 50. As shown, the ECI box 50 includes a controller circuit 130 shown in more detail in FIG. 8, a display circuit 140 shown in more detail in FIG. 9, input signal conditioning circuitry 150 shown in more detail in FIG. 10, a power supply circuit 160 shown in more detail in FIG. 11, and first, second and third solenoid driver circuits 170, 180, 190 shown in more detail in FIGS. 12, 13 and 14, respectively. In the preferred embodiment, the box housing the entire assembly is encapsulated in a polymeric material to protect the assembly from vibration and the environment. While a range of polymeric encapsulant materials may be employed, including acrylics, plastics, epoxies, and the like, the encapsulating material chosen should preferably be thermally conductive in order to dissipate heat generated by the internal components. The encapsulant should preferably also have a low coefficient of thermal expansion in order to reduce stress on the embedded components and be sufficiently hard to adequately protect such components. If an epoxy is used, the catalyst should also demonstrate thermal shock and impact resistance. While commercially available, thermally-conductive epoxy encapsulants with suitable catalysts have been found to provide preferred performance characteristics, other materials which provide the necessary sealing and protection of the internal circuitry against environmental factors may also be used.

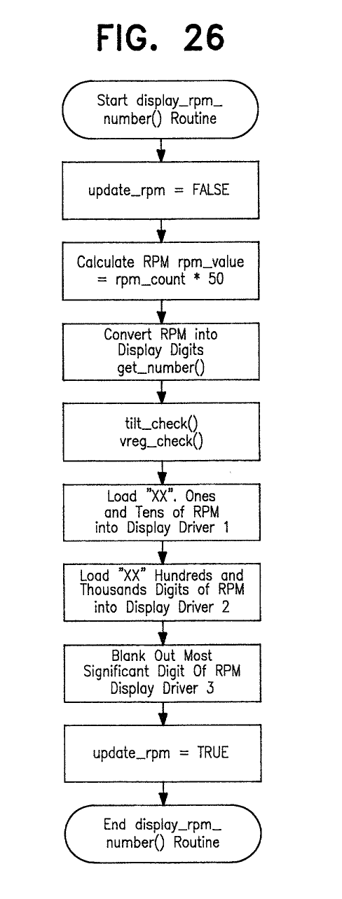

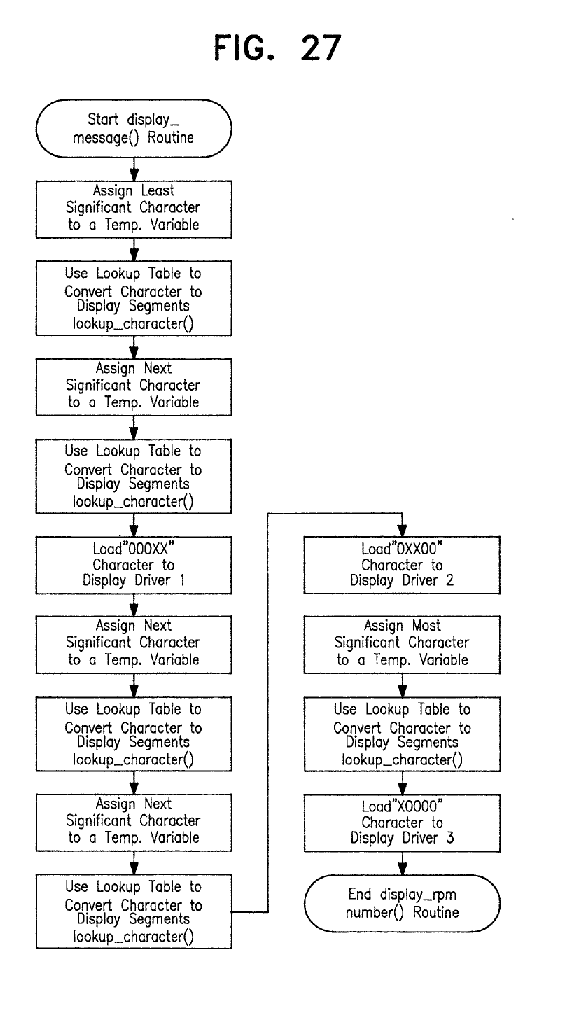

The input signal conditioning circuitry includes a plurality of equipment sensors for monitoring operation of the construction equipment or vehicle being controlled by the ECI box 50. These sensors include fault indicating sensors and warning indicating sensors as have already been described. The display circuit presents pertinent engine operating parameters to an operator in response to direction received from the controller circuit. The operation of the ECI box is functionally set forth in the flowcharts of FIGS. 15-28.

In response to the application of power to the ECI box, an initialization routine is executed as depicted in FIG. 15. This routine, which is executed whenever battery power is applied to the ECI box, initializes the microcontrollers input/output pins, variables, and interrupts; resets the battery; and puts the remote to sleep.

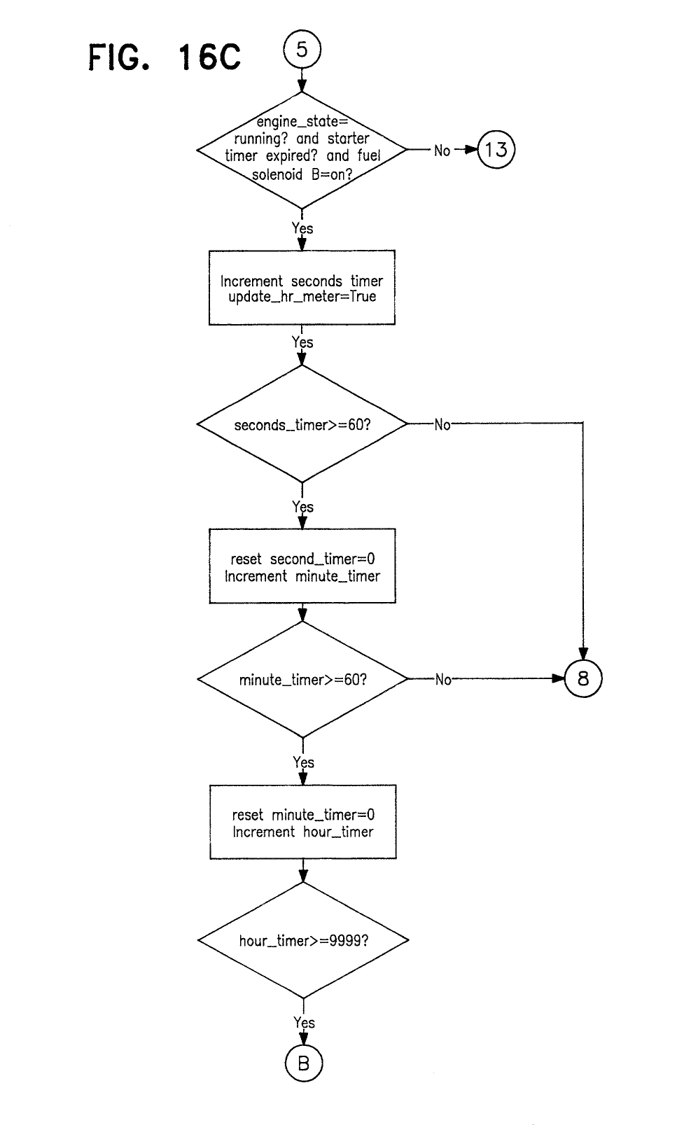

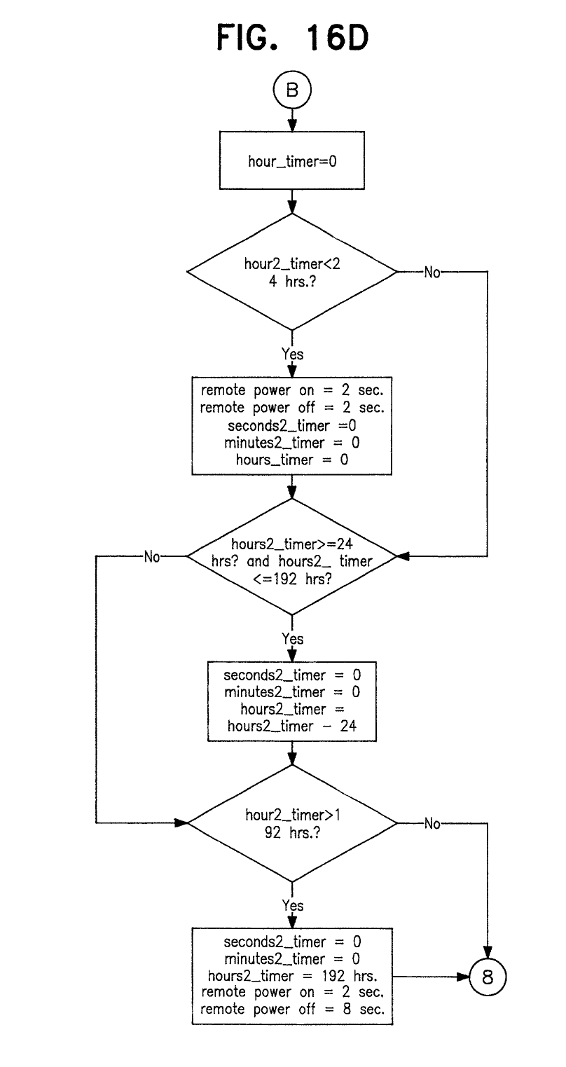

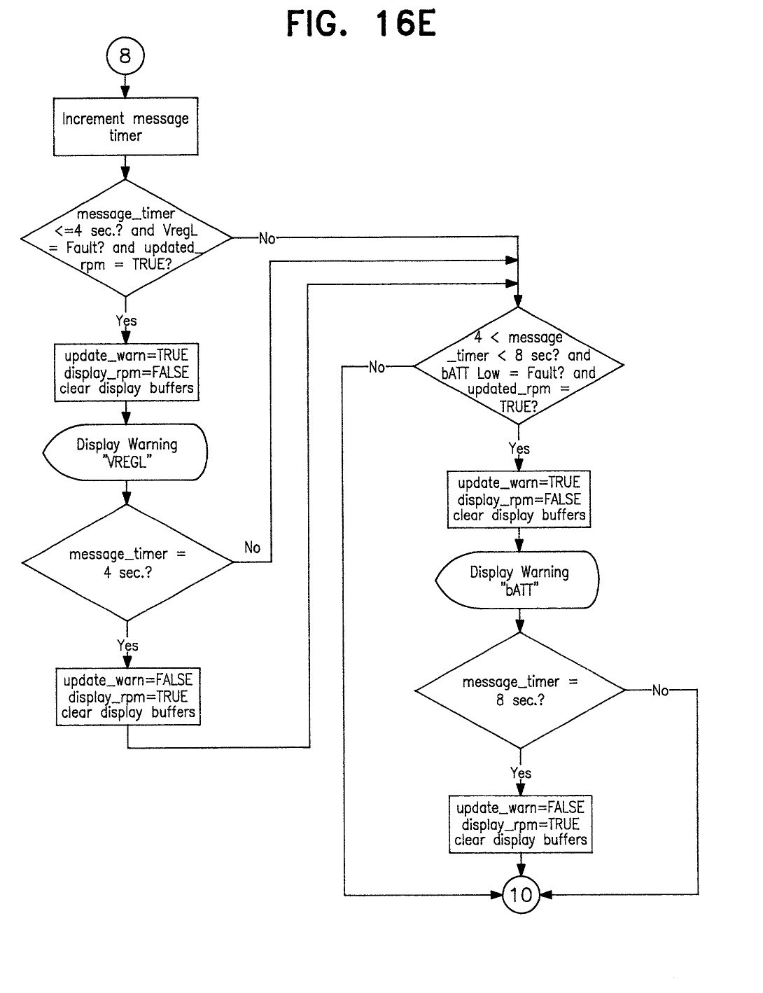

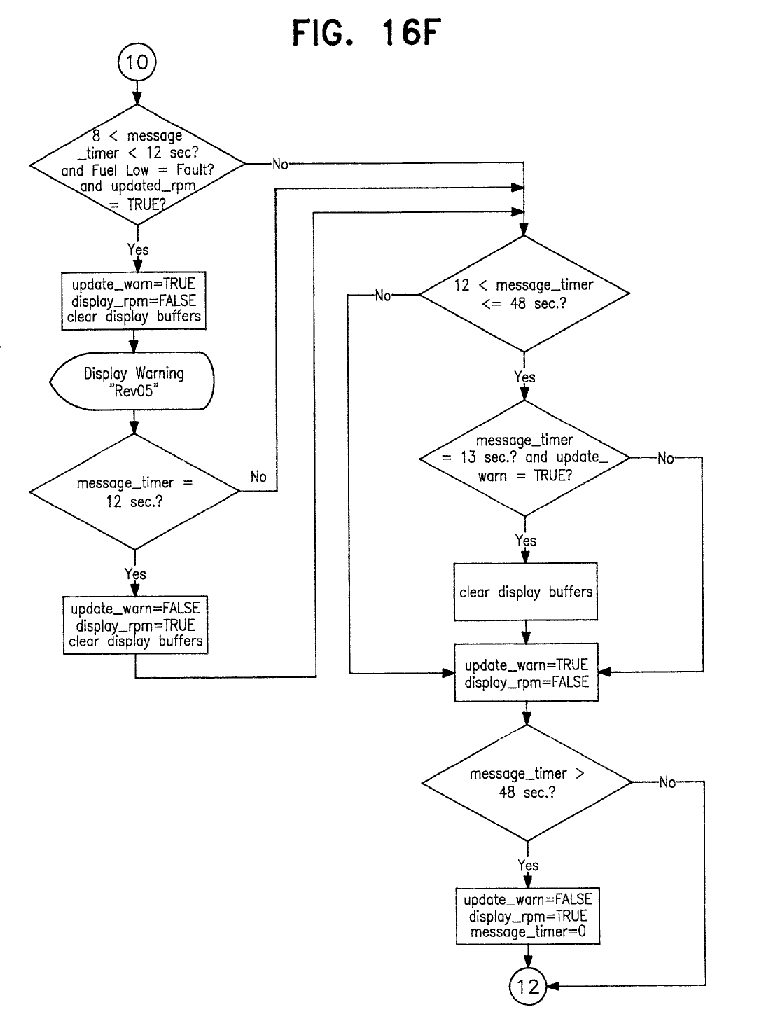

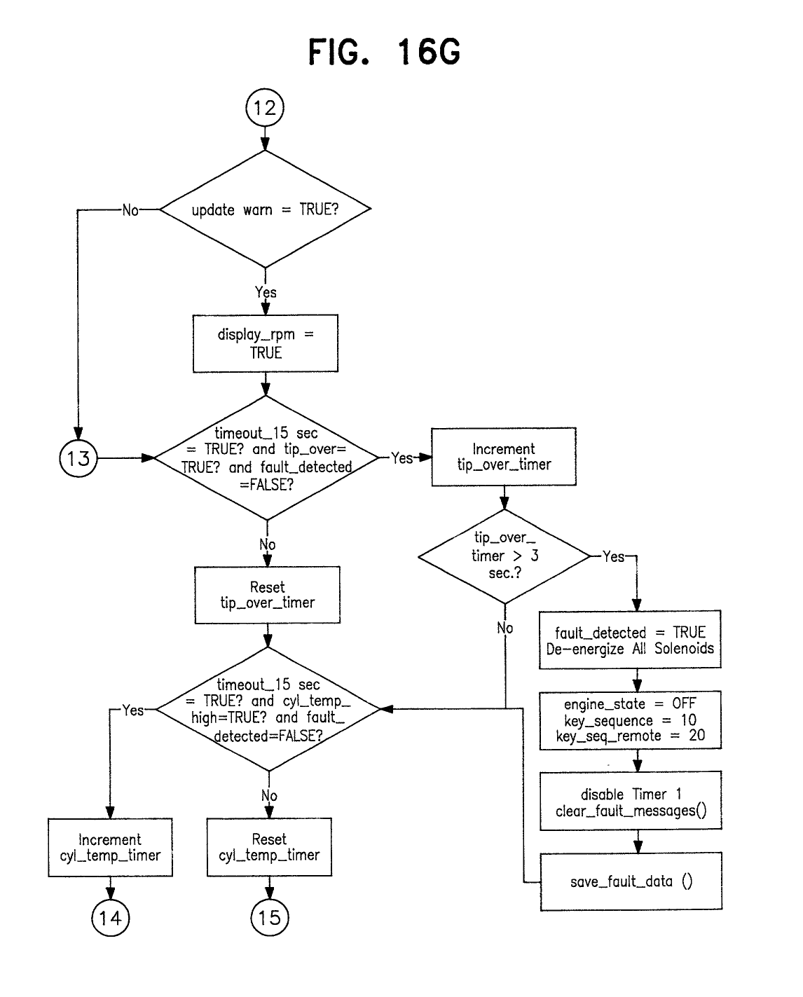

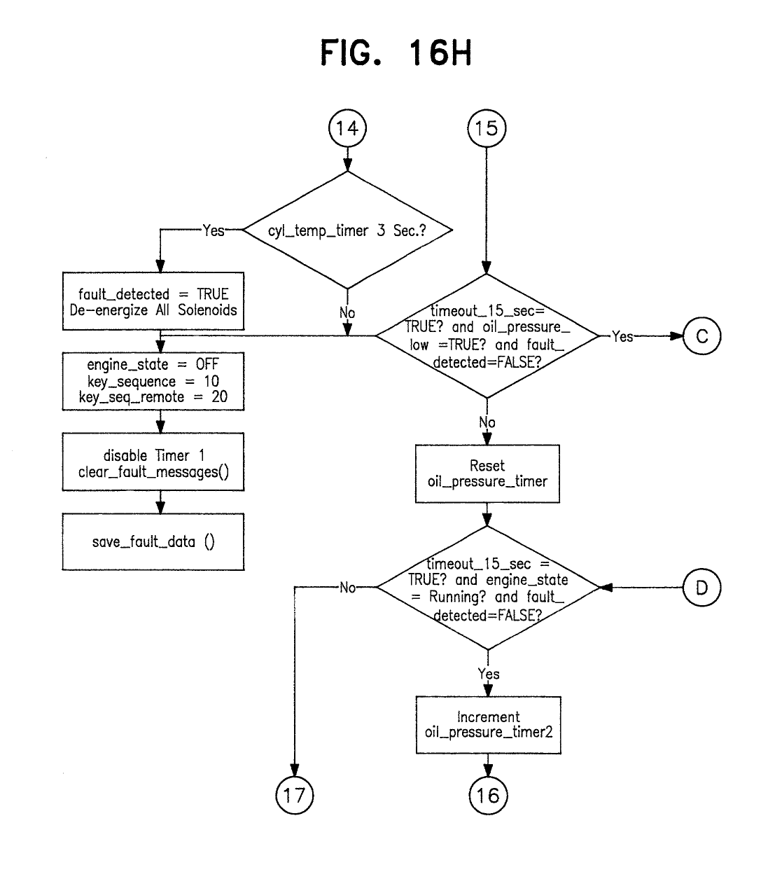

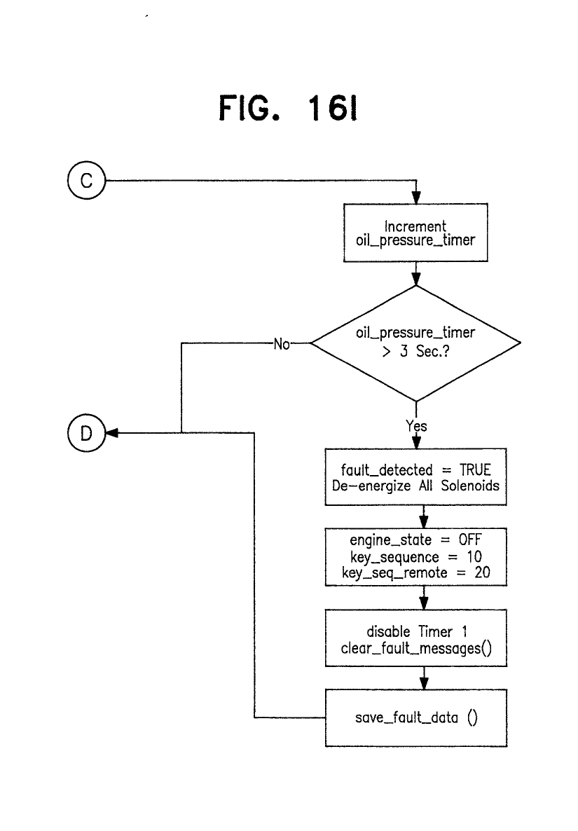

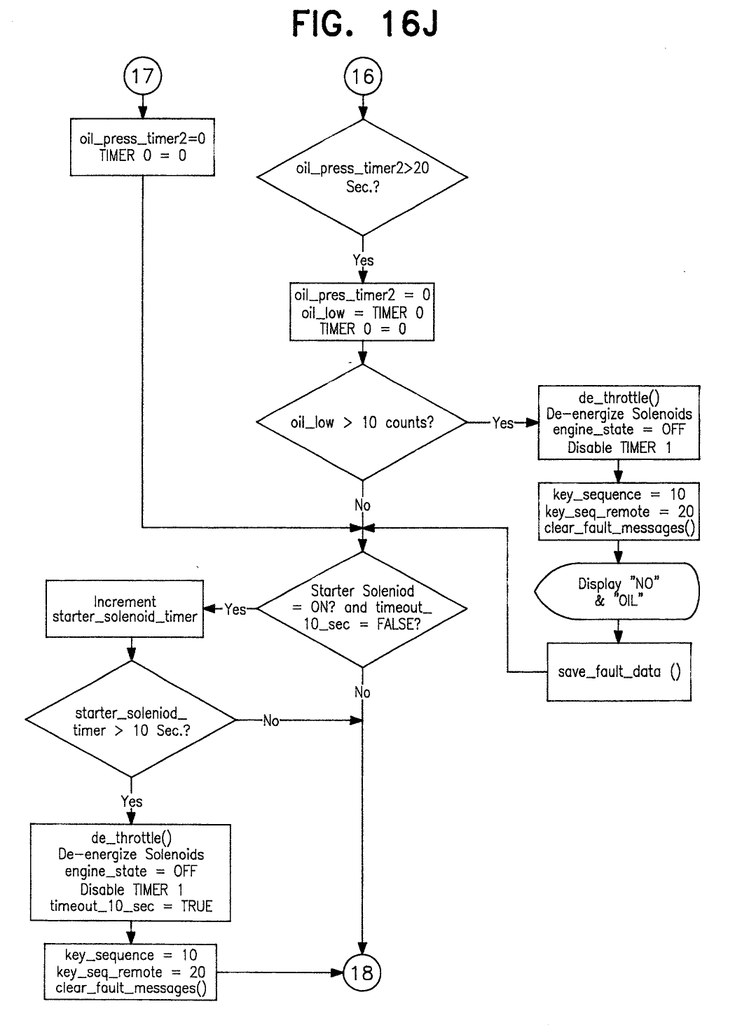

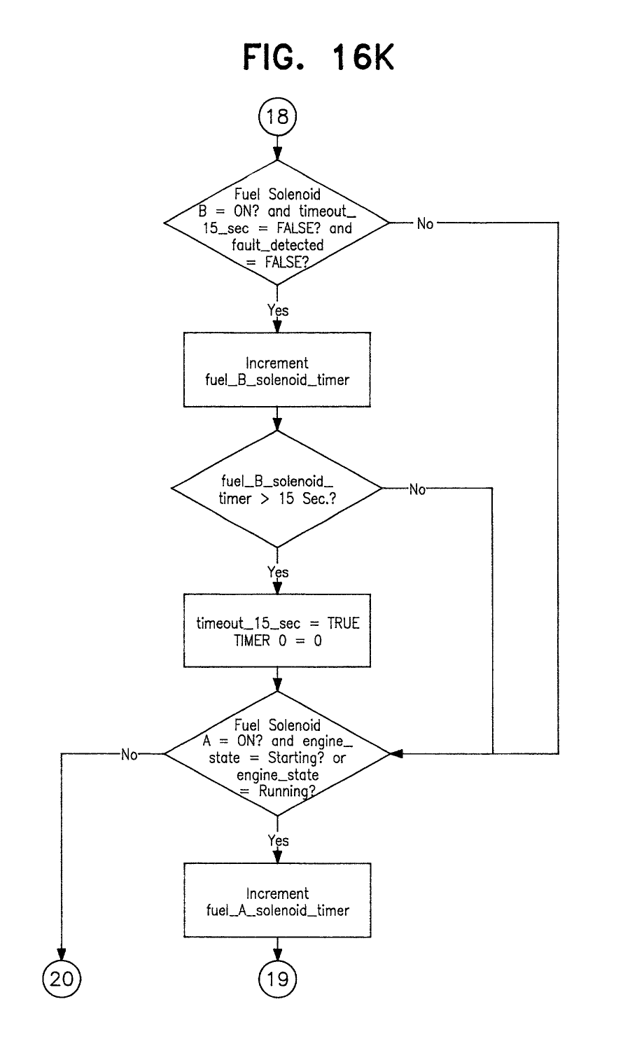

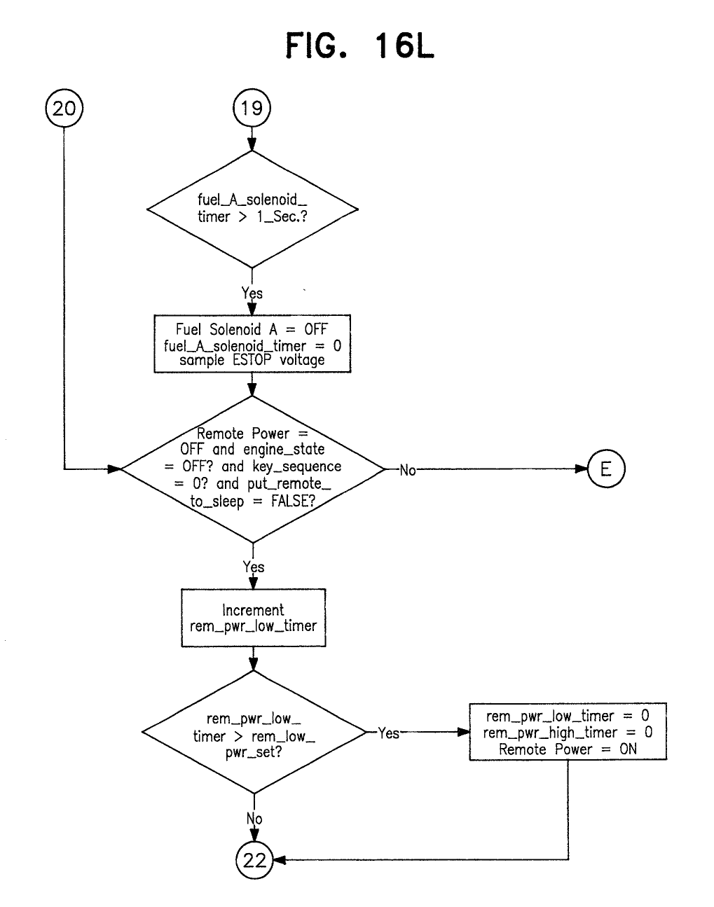

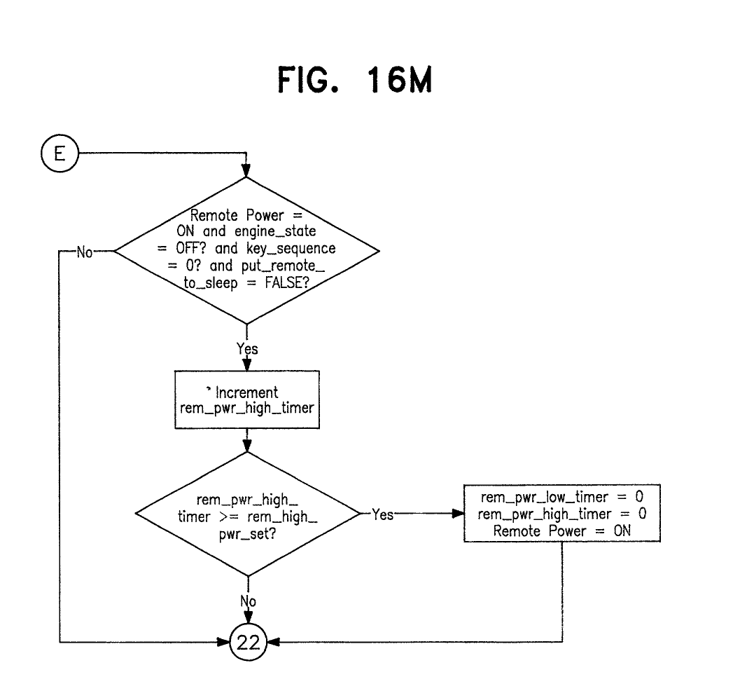

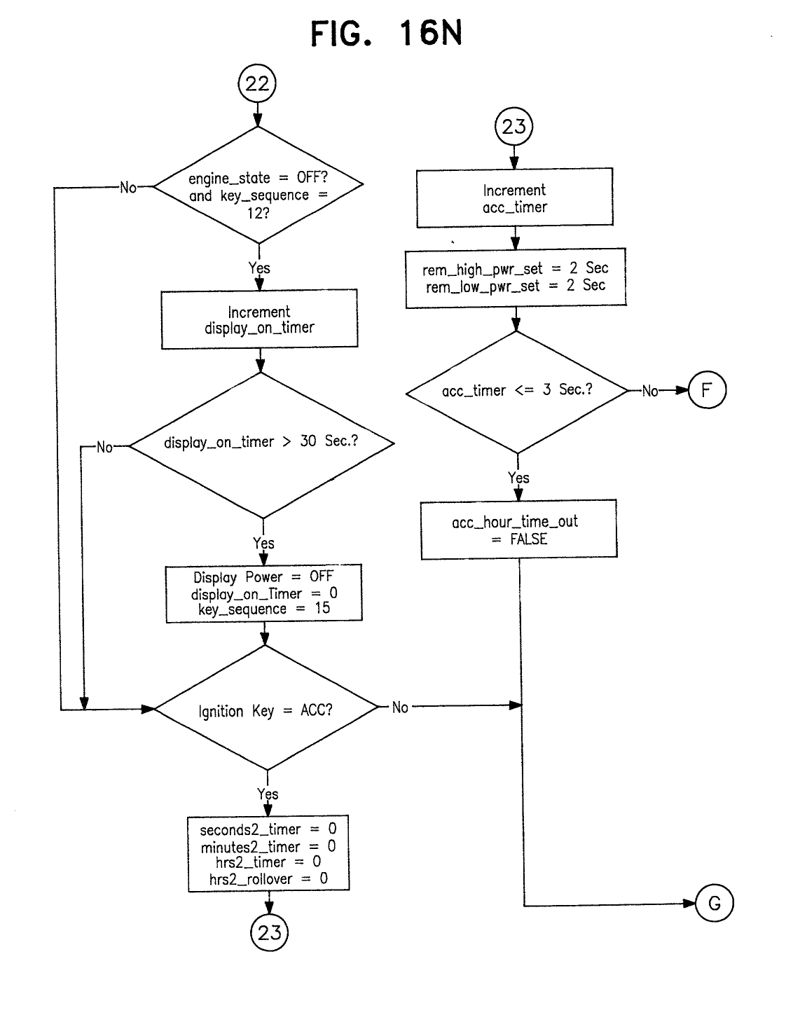

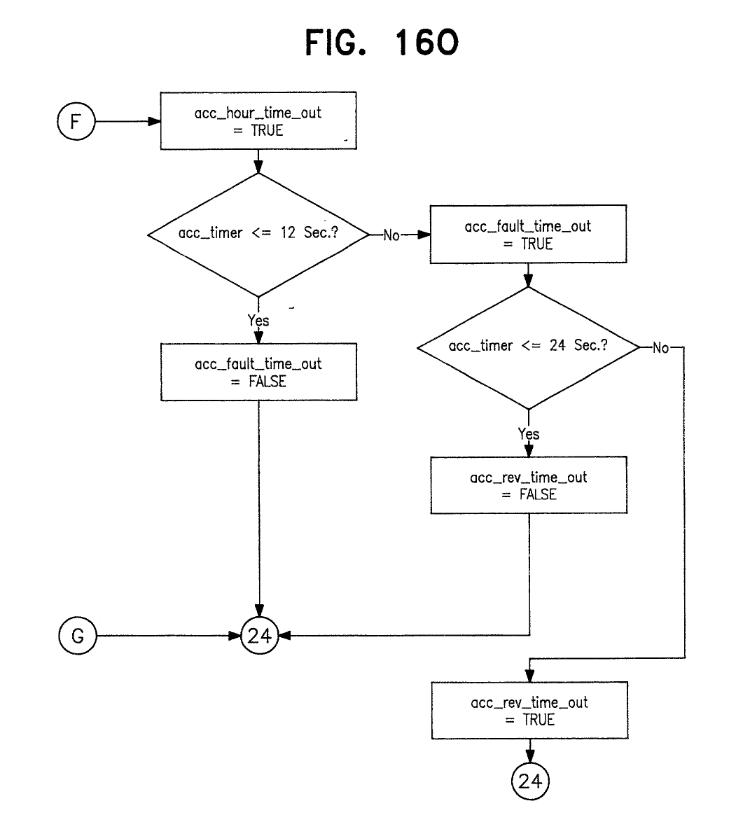

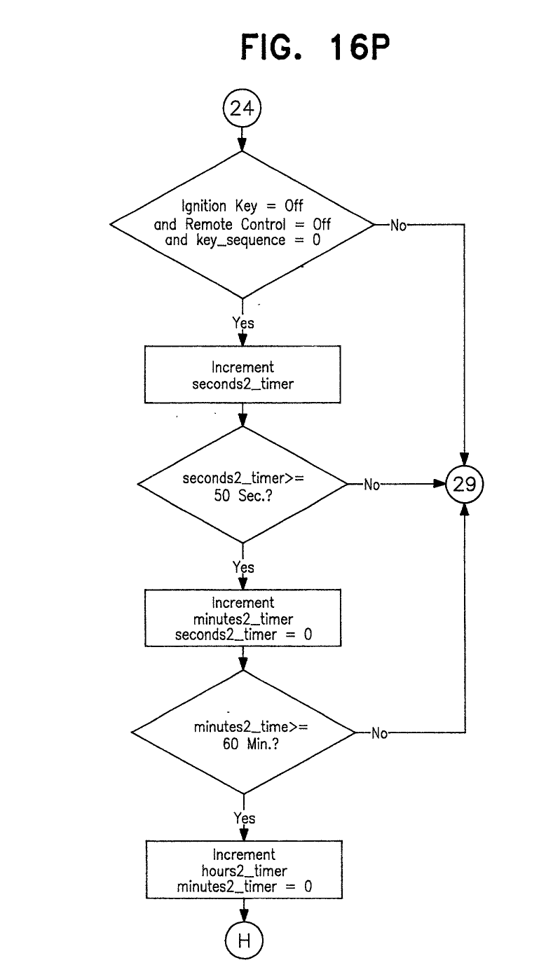

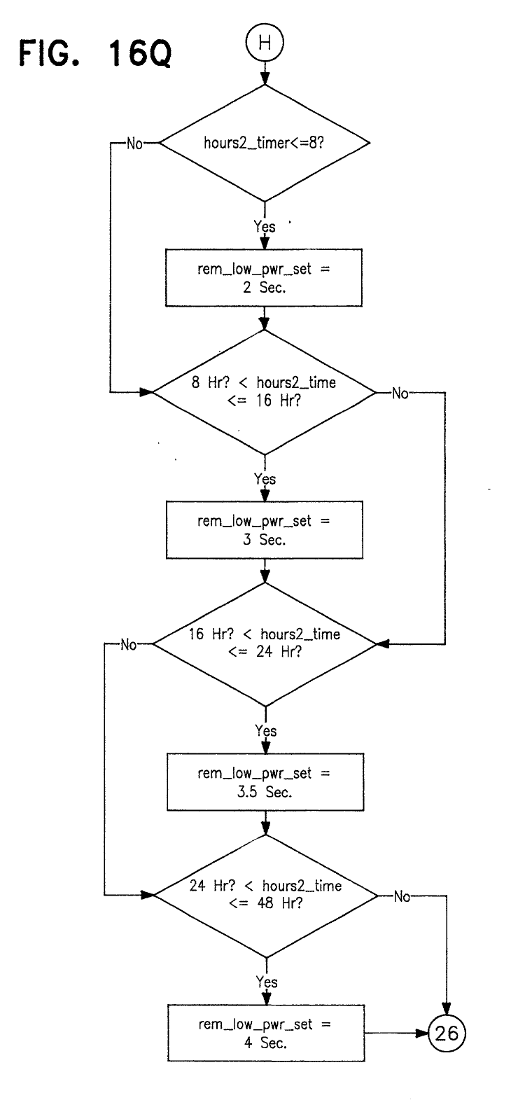

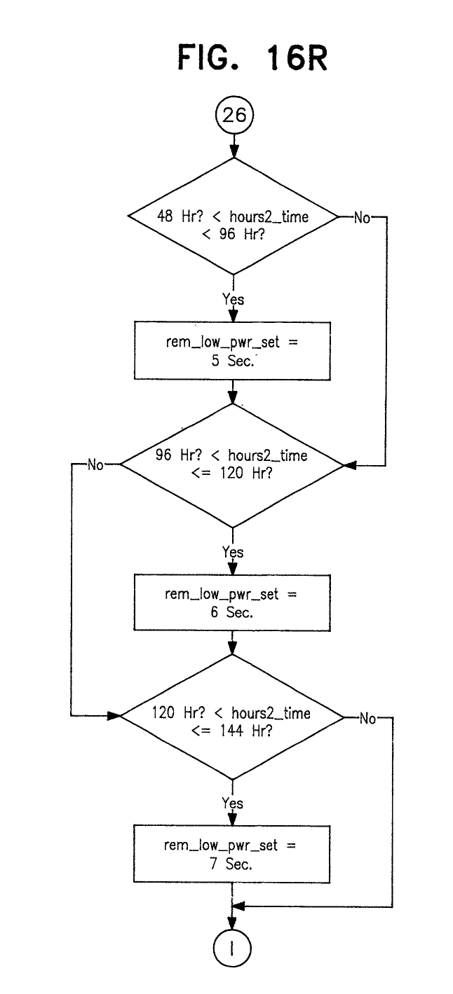

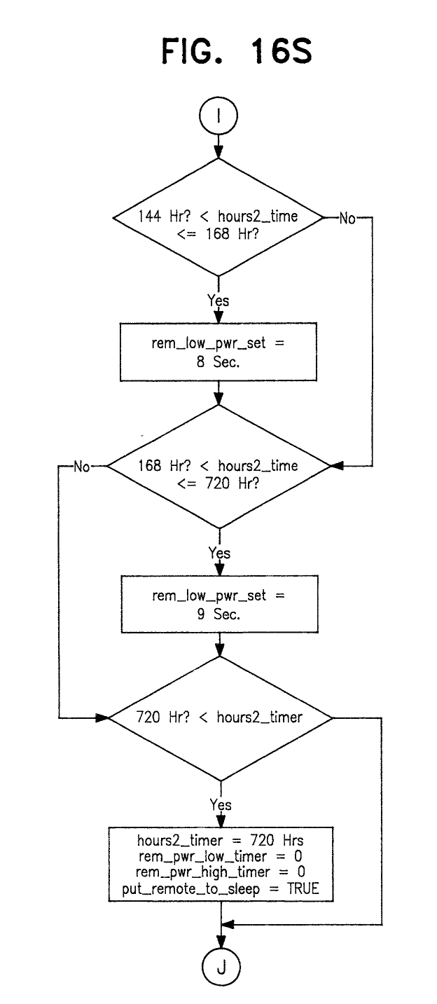

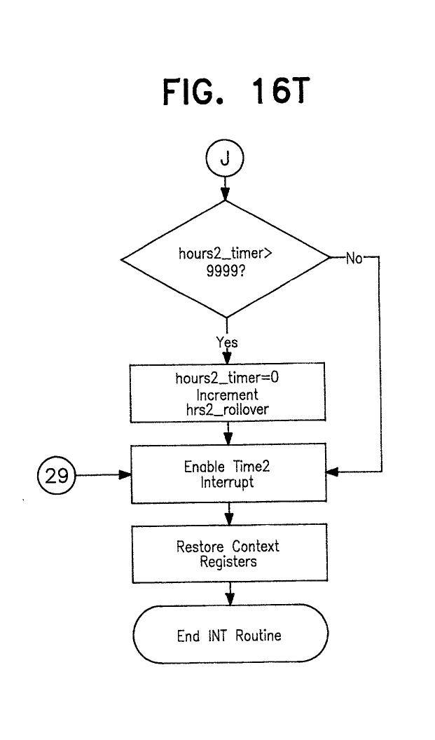

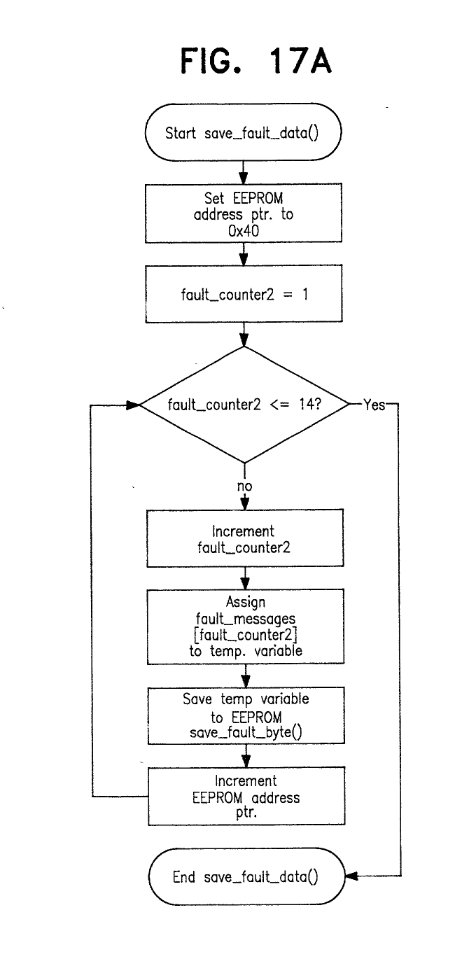

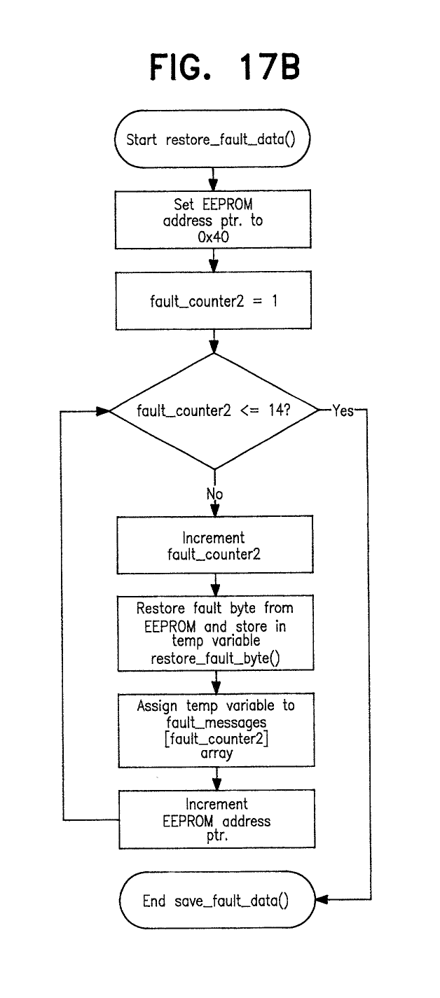

FIGS. 16A-16K summarize the INT routine of the ECI box, in accordance with the present invention. The INT routine is executed every 0.25 seconds and performs a number of functions including sensing motor speed and shutting the engine down if the revolutions per minute (RPM's) are below a predetermined threshold, engaging the starter motor for 0.75 seconds upon initial start-up, sensing manual throttle switch input and de-energizing the solenoids, energizing remote power based on ignition switch and system on/off time, displaying message timing, resetting solenoid timers and updating the hour meter. In a preferred embodiment, the first timer (Timer 1) is the RPM counter, and the second timer (Timer 2) is a 0.25 second timer, as set in the initialization routine.

As depicted in FIG. 16A, when starting, the starter motor needs to be engaged for approximately 0.75 seconds in order for the RPM to be stable. Thereafter, when in the manual mode, the throttle switch must be turned on in order for the throttle solenoids to be energized. In the remote mode, the throttle solenoid is engaged automatically after the starter motor solenoid is disabled.

Updating of the hour meter, generally summarized in FIG. 16B, allows the use of engine on-time to be tracked. This can be particularly useful in machine rental situations. The battery timer also keeps track of system on-time and, as shown in the Figure, increases the time the remote solenoid is on as the system on-time increases.

FIG. 16C presents the steps undertaken for the display of battery charging and voltage status. If the generator is not charging the battery properly, the LCD display 24 will flash a warning message. Similarly, if the battery voltage is low, the LCD display will flash a “bat low” warning message.

FIG. 16D summarizes an optional fuel fault warning routine, and updating and clearing of the display. If no warnings exist, then engine RPM is displayed (see FIG. 16E). With regard to the tilt switch operation, in a preferred embodiment the tilt switch is a normally open-contacts tip switch. During normal operation of the trench roller, the leads associated with the switch are not connected but, should the switch be tilted past a threshold, the leads are connected to complete the switch and trigger engine shut-down. Such switches are known to persons of skill in the art.

Due to the inherent vibration of the trench roller during normal operation, rolling of the mercury often results in brief connections of the leads in the tilt switch for which engine shut-down would be inappropriate. Accordingly, as shown in FIG. 16E, when activation of the tilt switch is sensed, a trip will only occur if the switch is on for a duty cycle greater than approximately 62%. Other durations of switch closure prerequisite for engine shut-down may, of course, be implemented.

Fault detection steps for oil pressure detection and timing are set forth in FIGS. 16F and 16G. In a preferred embodiment, Timer 0 is set to count oil pressure switch closures. If Timer 0 counts more than ten oil pressure closures or pulses in a 20 second period, the ECI box 50 will automatically shut down the trench roller engine. As also shown in FIG. 16G, the tilt, cylinder temperature and oil pressure switches are preferably sensed after 15 seconds although other intervals may also be established.

FIGS. 16H-16K summarize the updating of various timers in accordance with the present invention. When the ignition switch is set to the accessory position, the hour meter, fault and software revision code are displayed for a specified time and then the display shuts down to save power. As shown, the remote solenoid off-time is increased the longer the system is off.

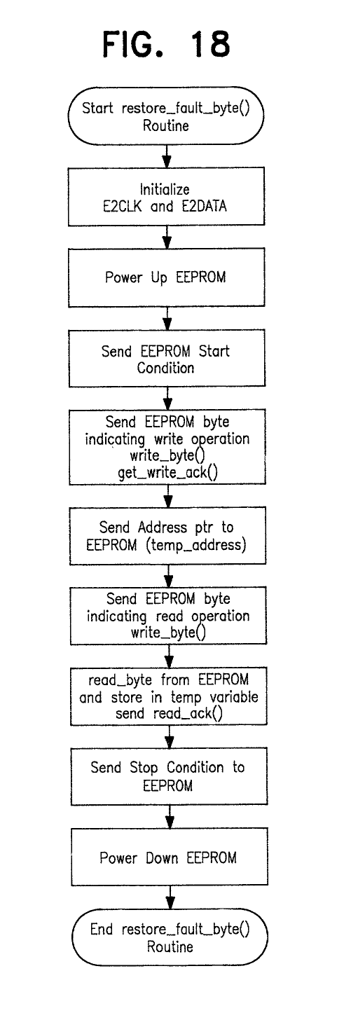

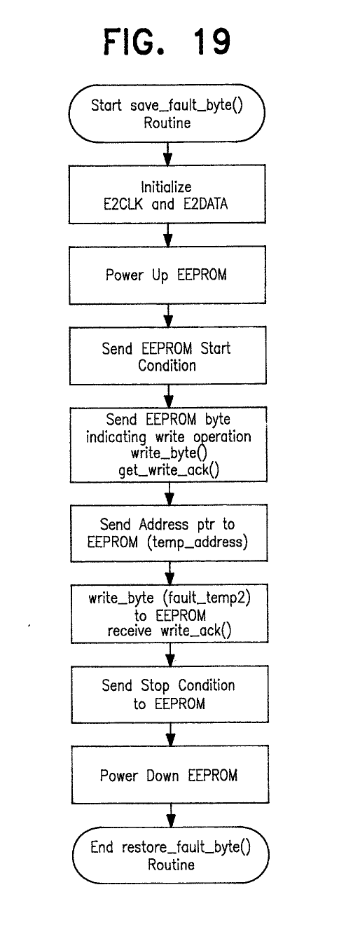

As set forth in FIGS. 17A and 17B, respectively, the save_fault_data routine saves the current fault to EEPROM, and the restore_fault_data restores the last fault from EEPROM and saves it to a fault message array. The restore_fault_byte routine of FIG. 18 restores fault byte from EEPROM, and the save_fault_byte routine of FIG. 19 saves fault byte to EEPROM.

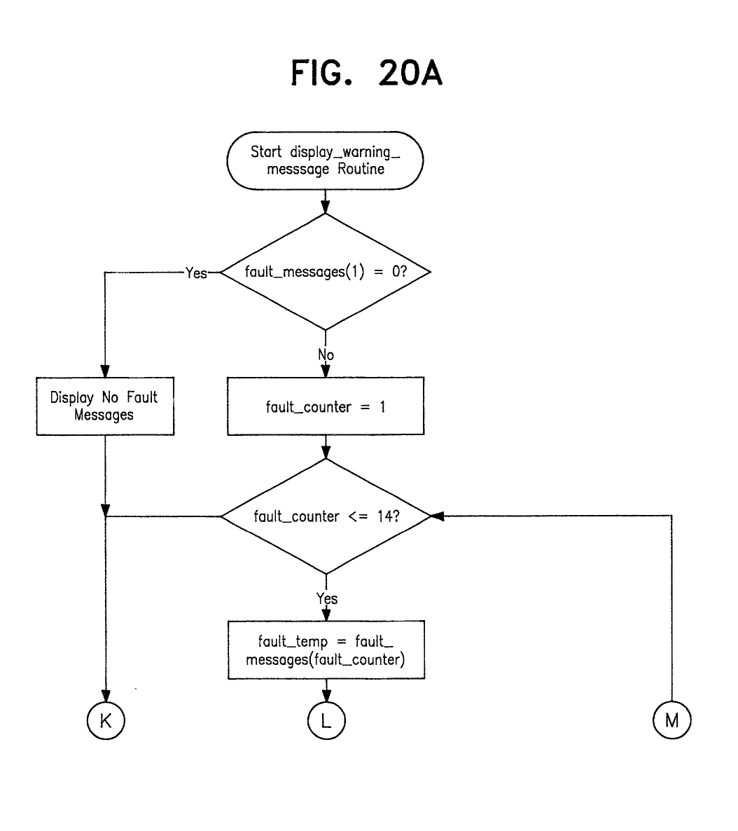

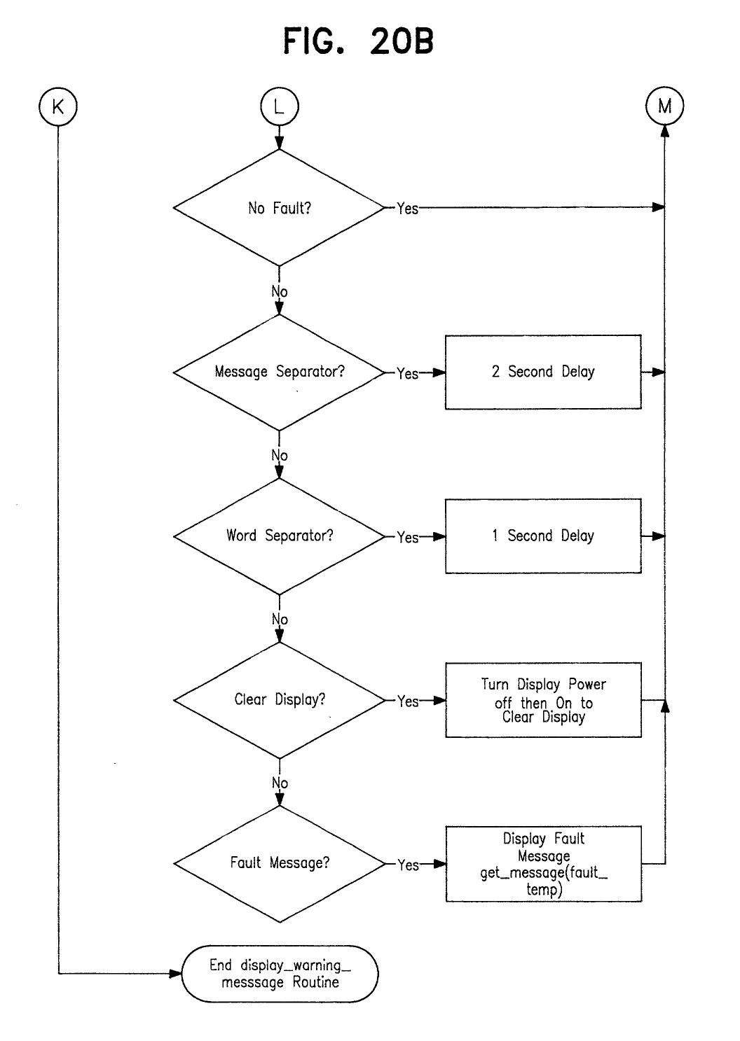

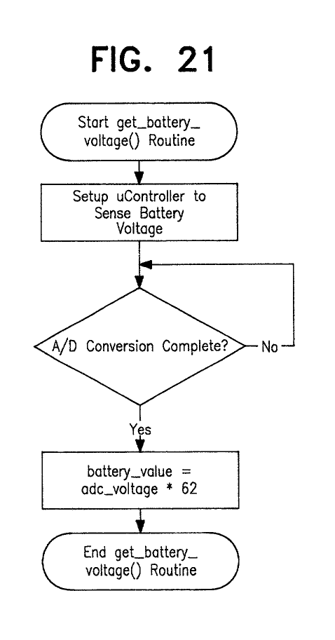

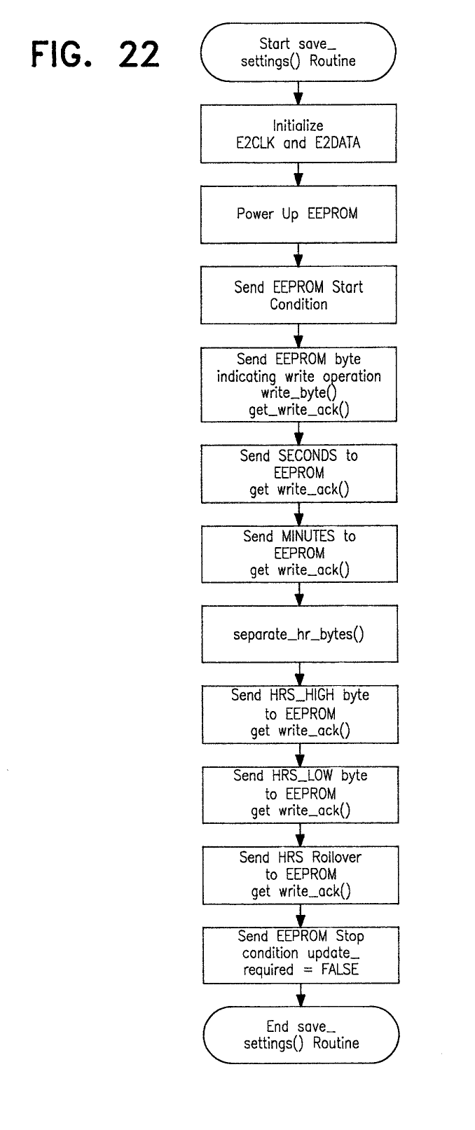

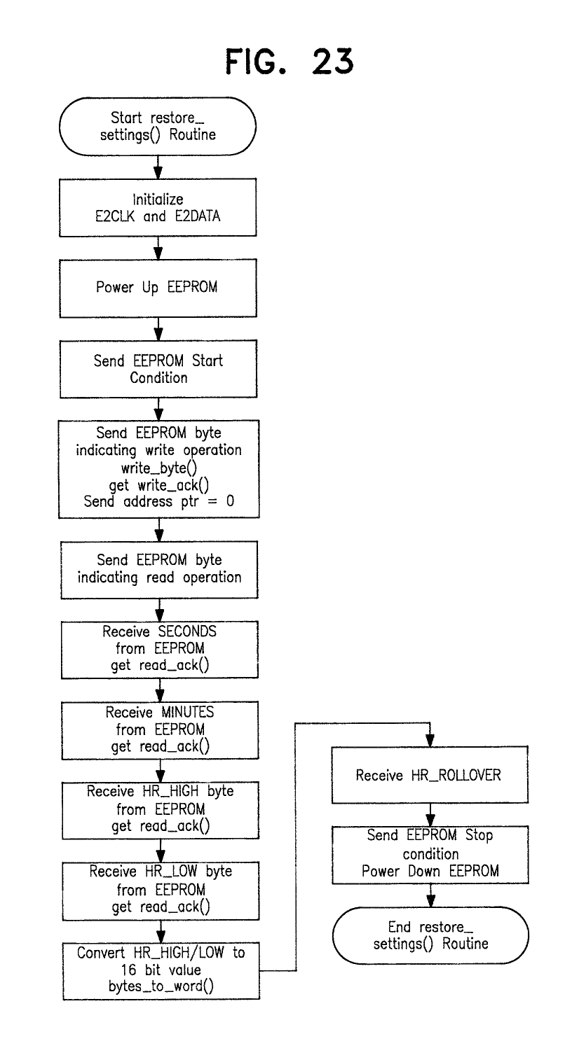

As shown in FIG. 20, the display_warning_message routine displays multi-word warning and fault messages. The get_battery_voltage routine of FIG. 21 retrieves battery voltage, with a 0.062 mV resolution and 16.065V full scale in a preferred embodiment. The save_settings routine of FIG. 22 saves the hour timer to EEPROM, and the restore_settings routine of FIG. 23 restores the hour timer from EEPROM.

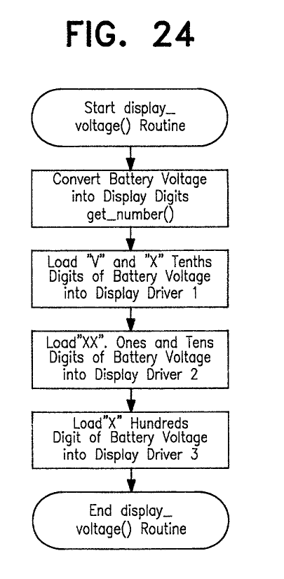

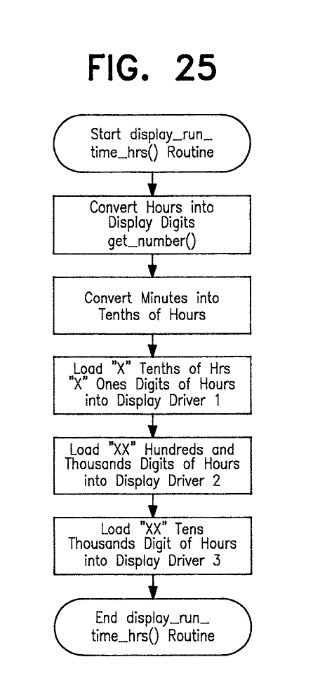

Routines for the display of voltage, hours of engine operation, RPM, and warning and fault messages are summarized in FIGS. 24-27, respectively. As has already been discussed, the number of engine hours is displayed when the ignition key is in the accessory position 26d, and RPM is displayed when the engine is running normally.

In a preferred embodiment, each warning and fault message has an assigned message number. A “get message” routine uses a lookup table to find the appropriate message to be displayed based on the fault/warning message number. The use and accessing of look-up tables is well known in the art.

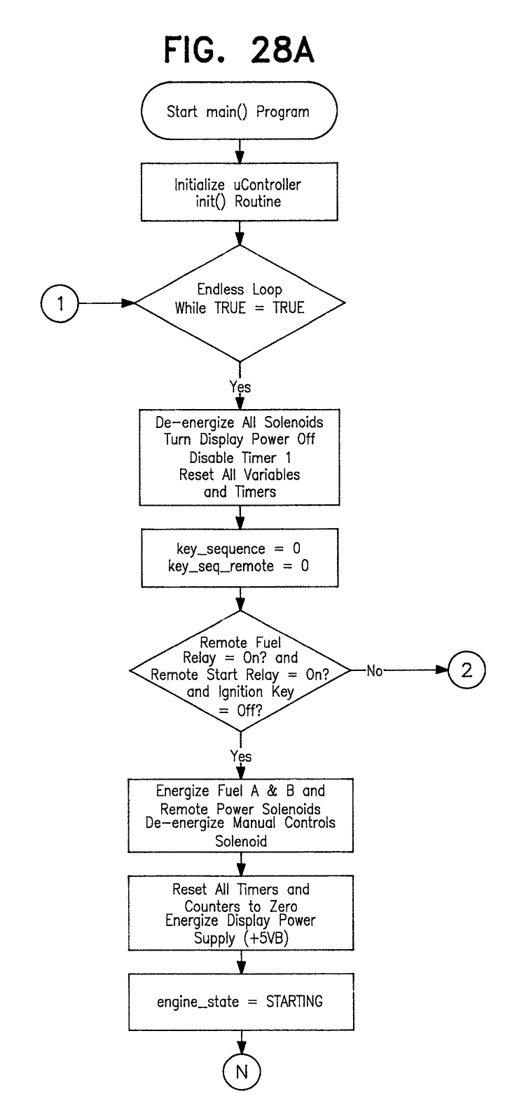

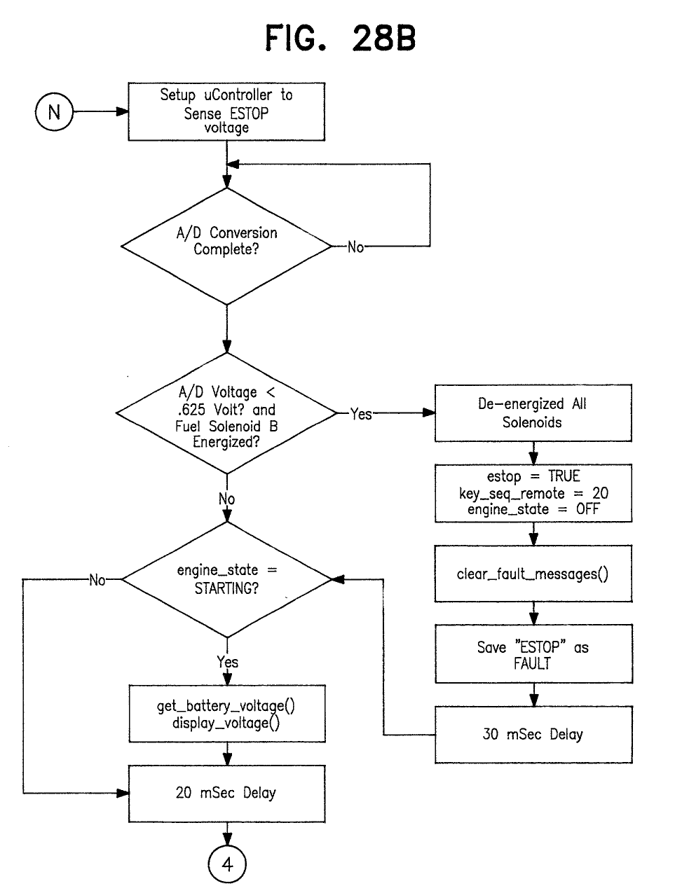

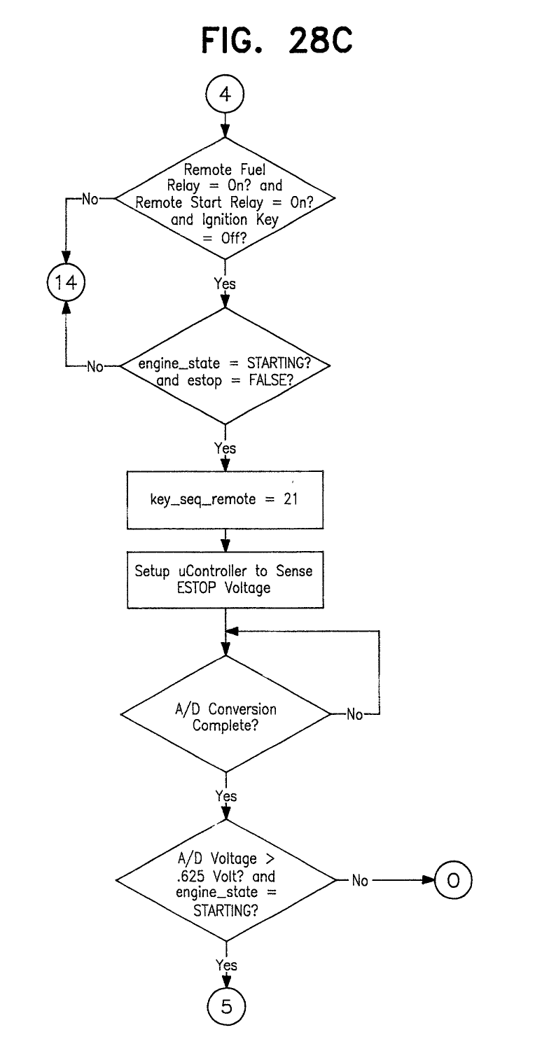

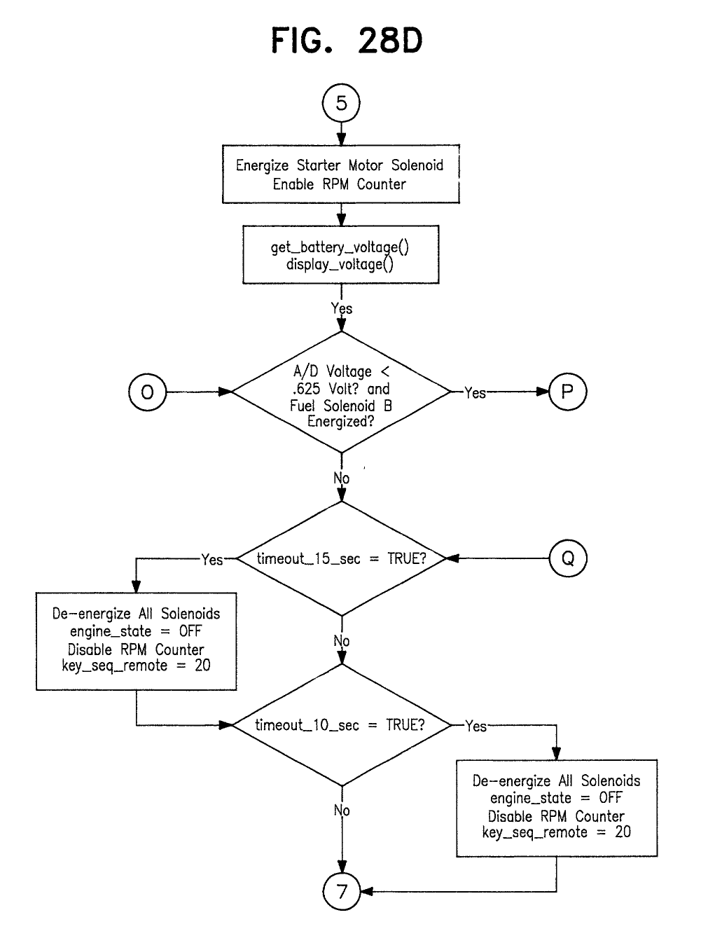

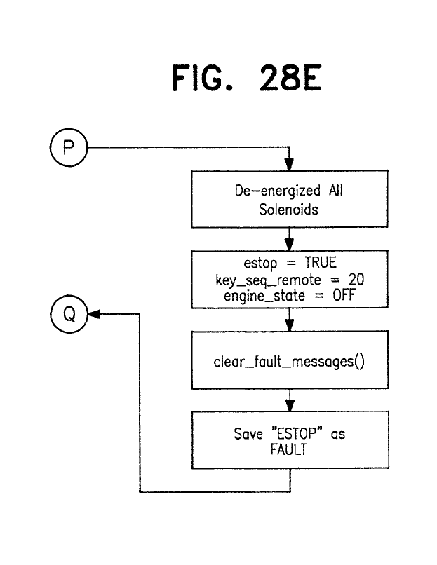

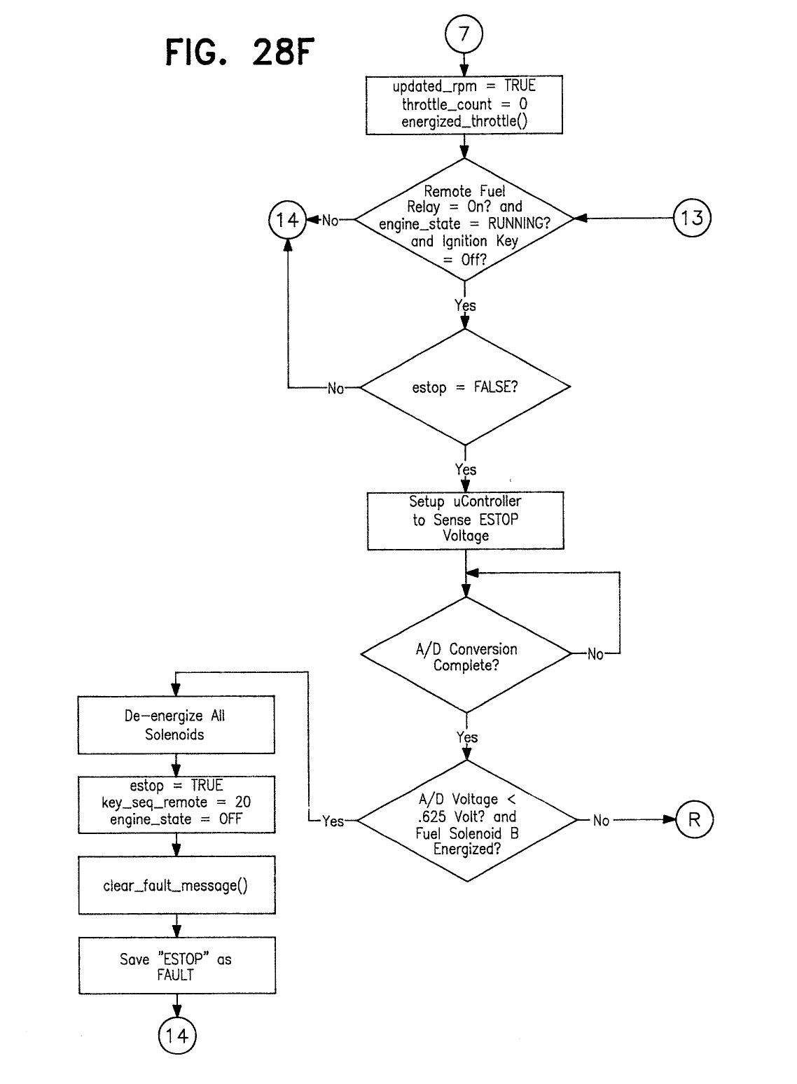

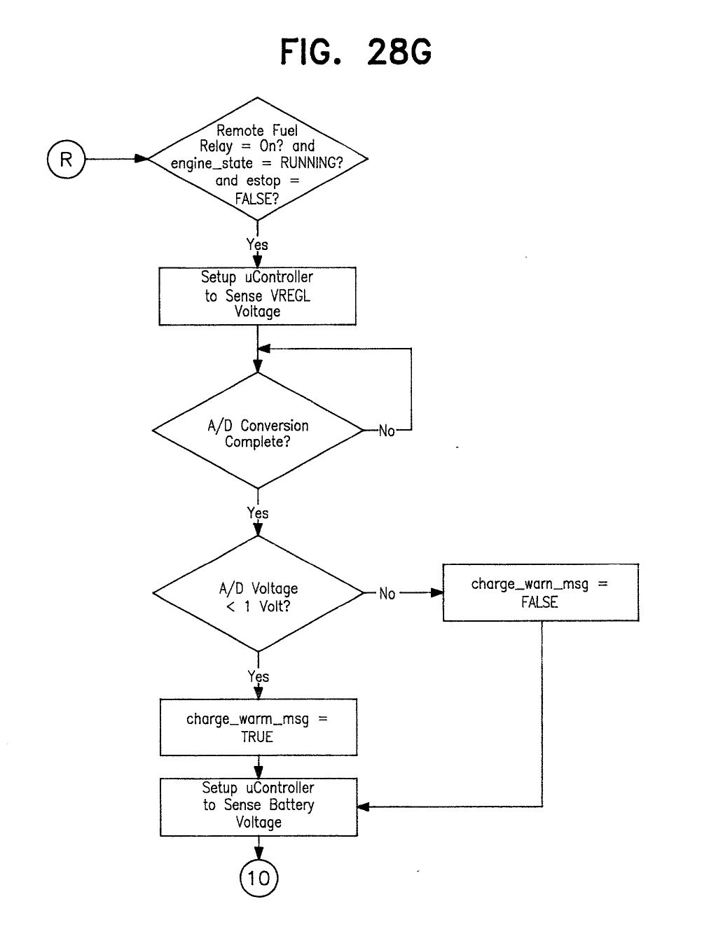

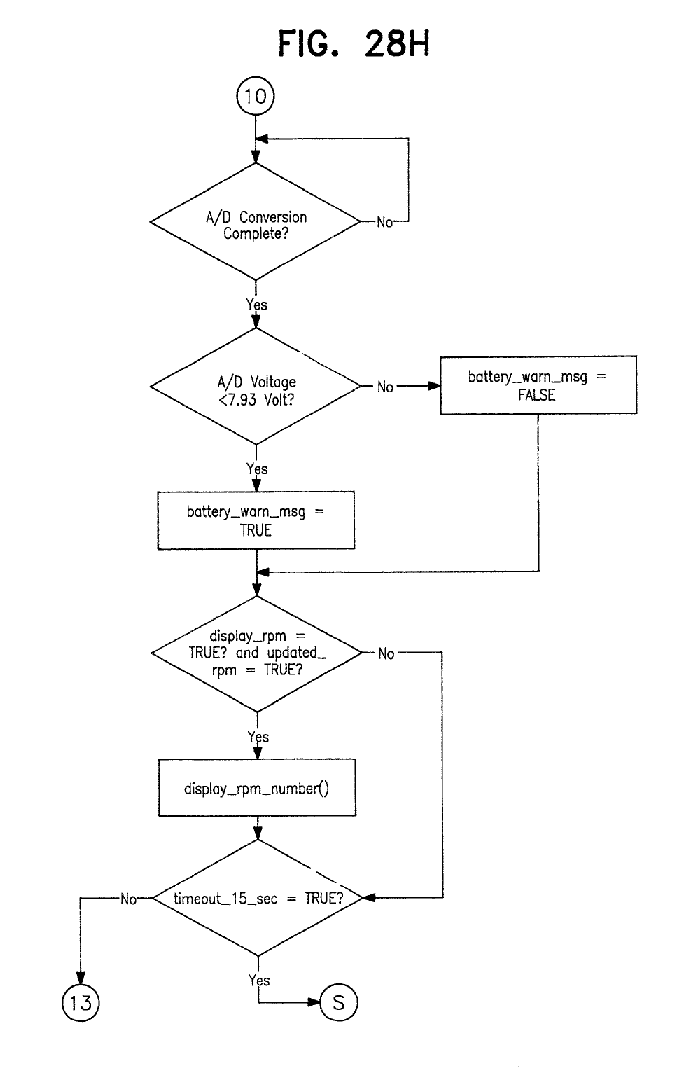

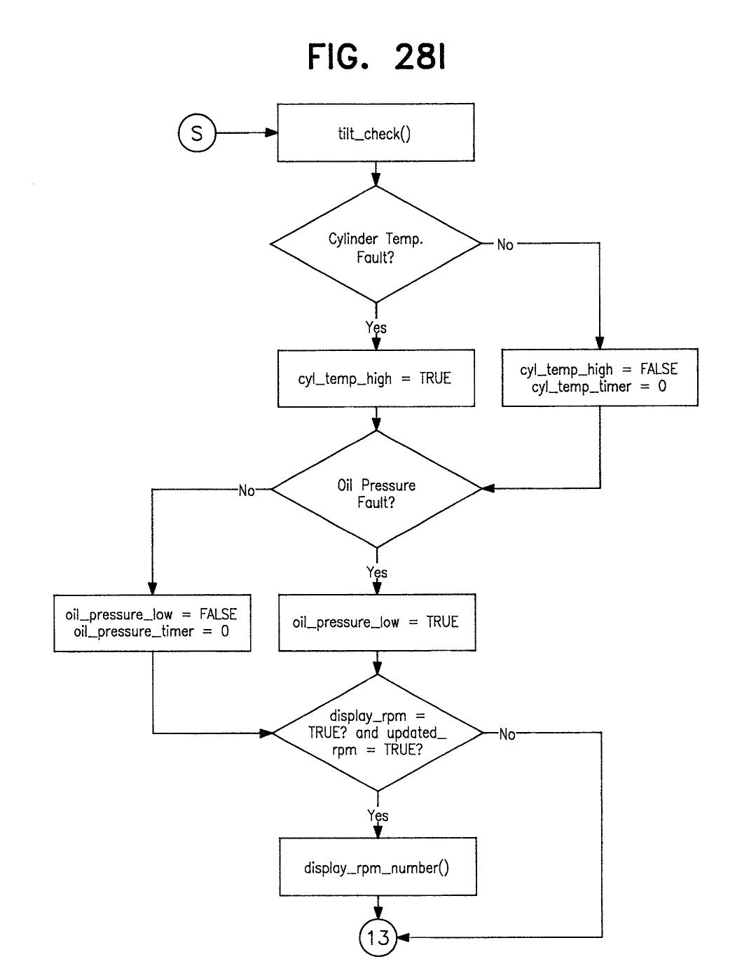

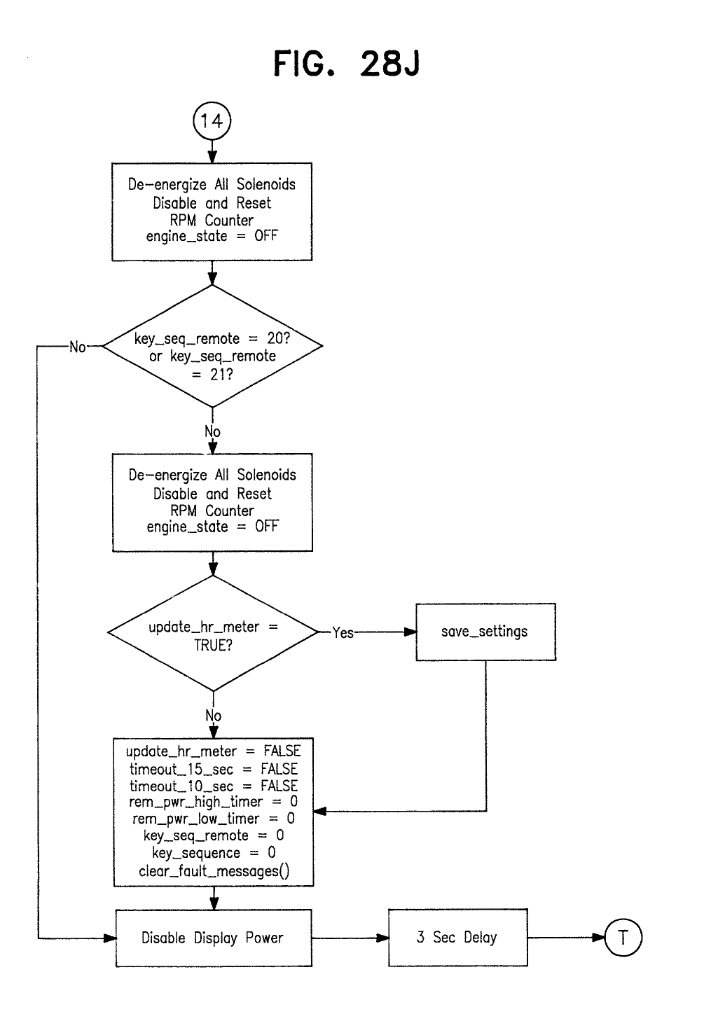

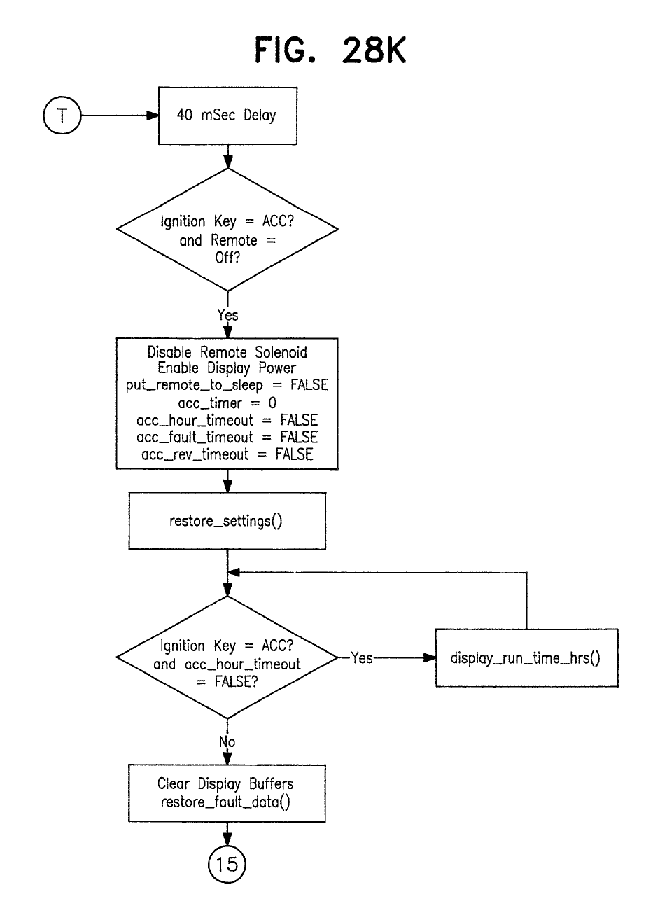

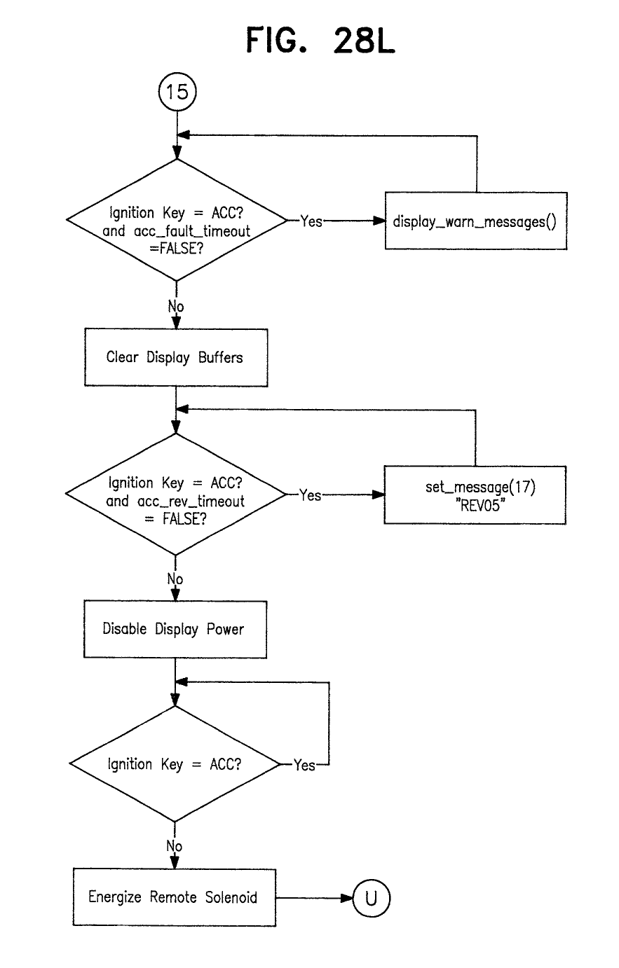

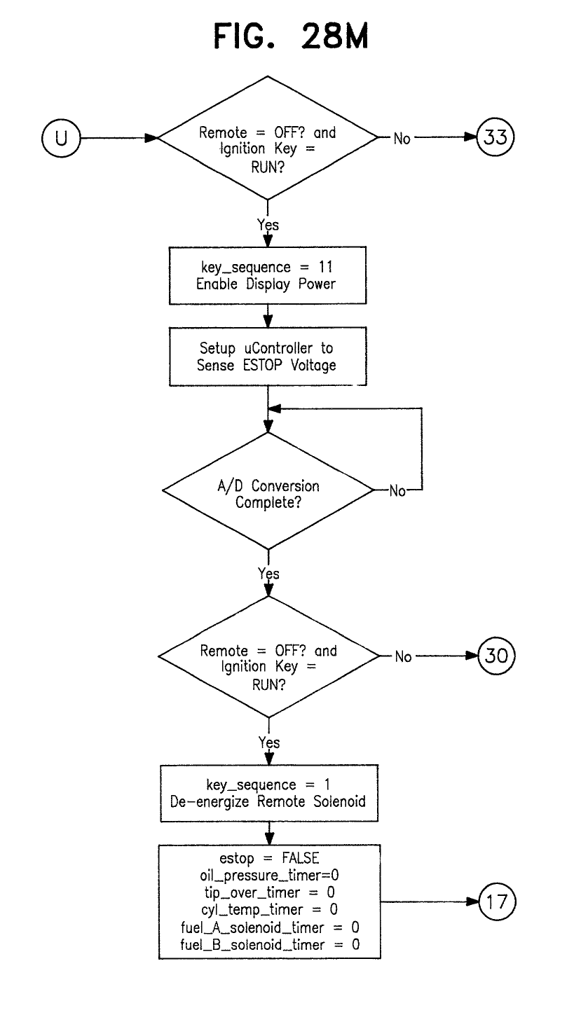

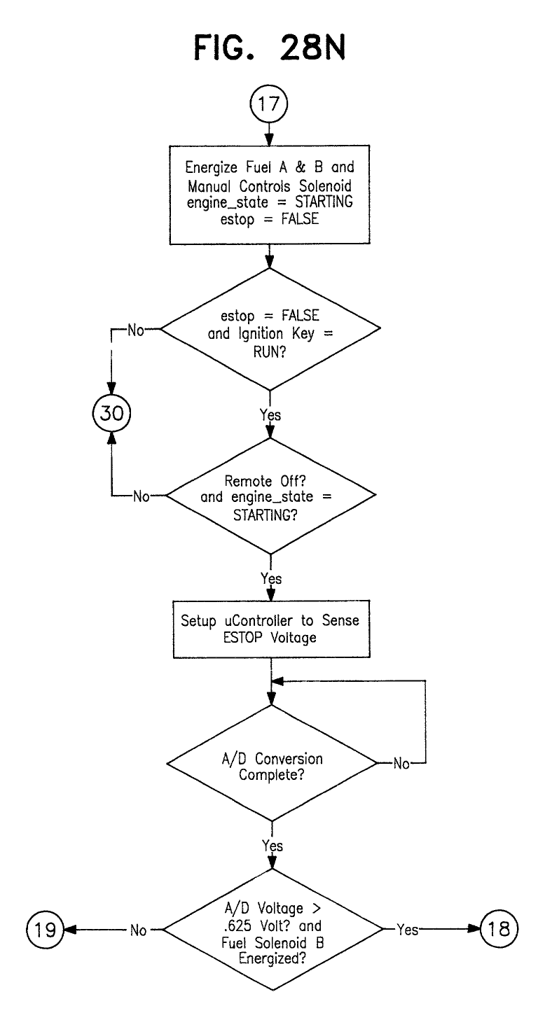

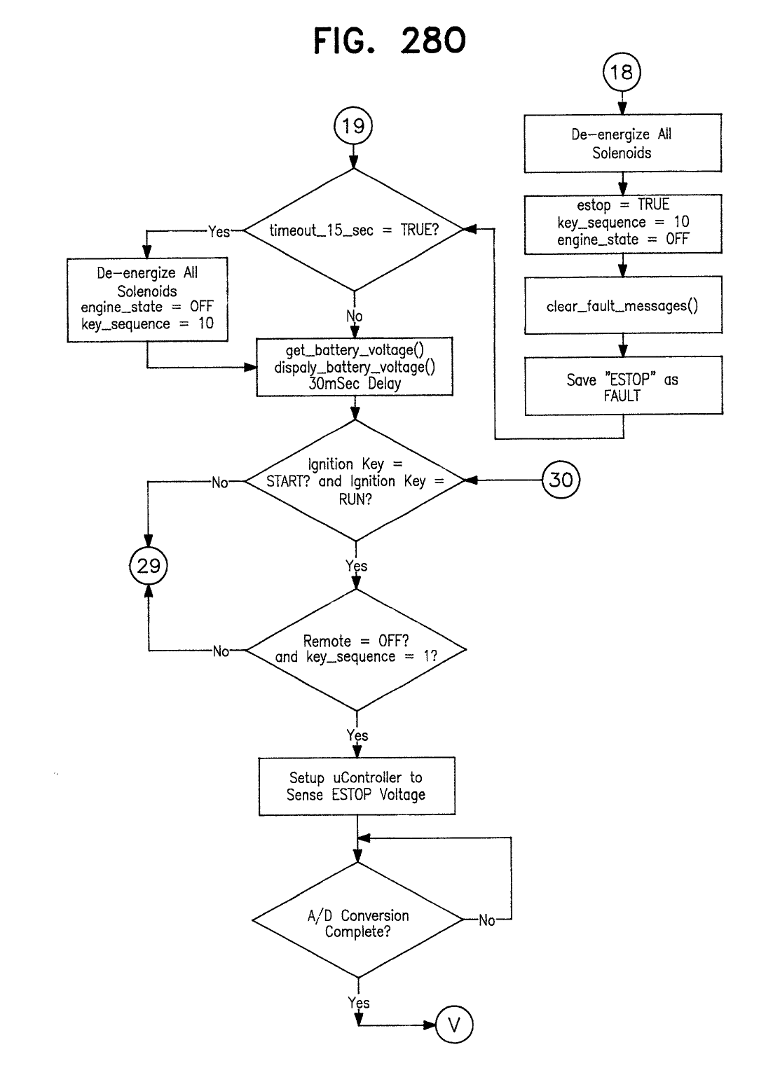

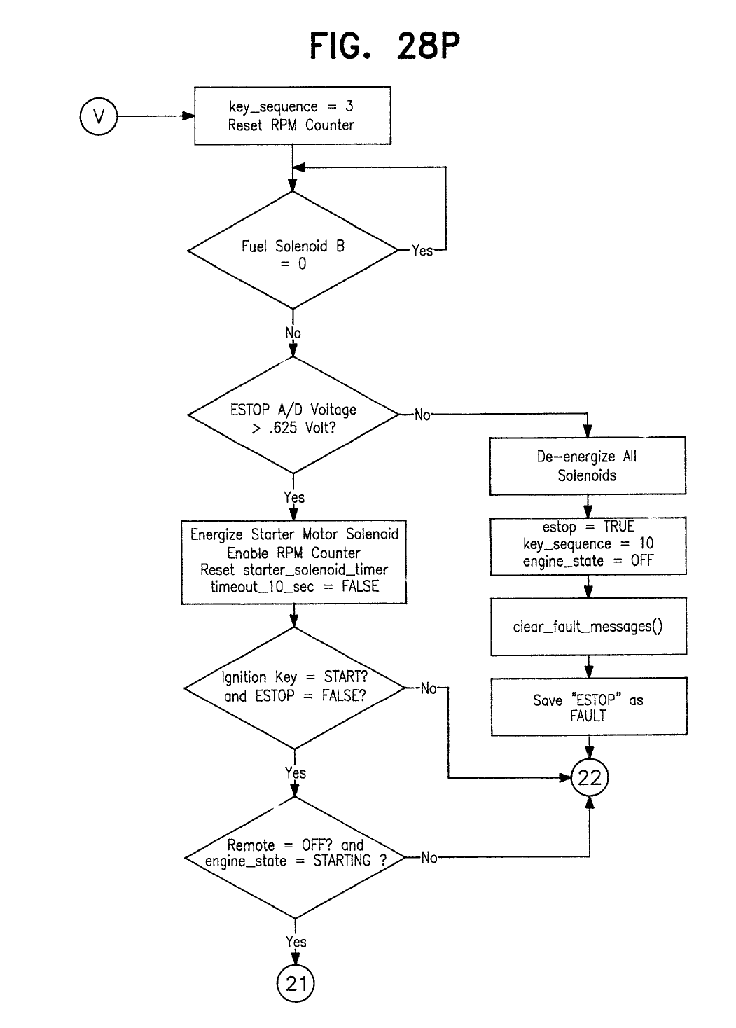

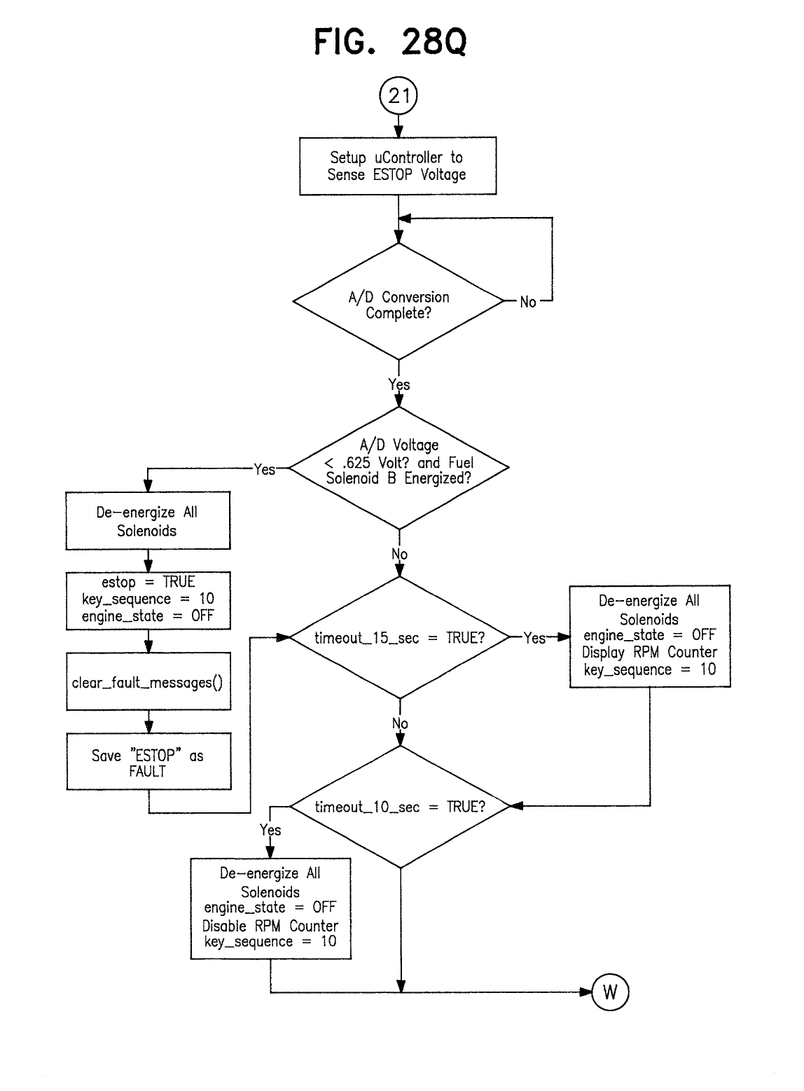

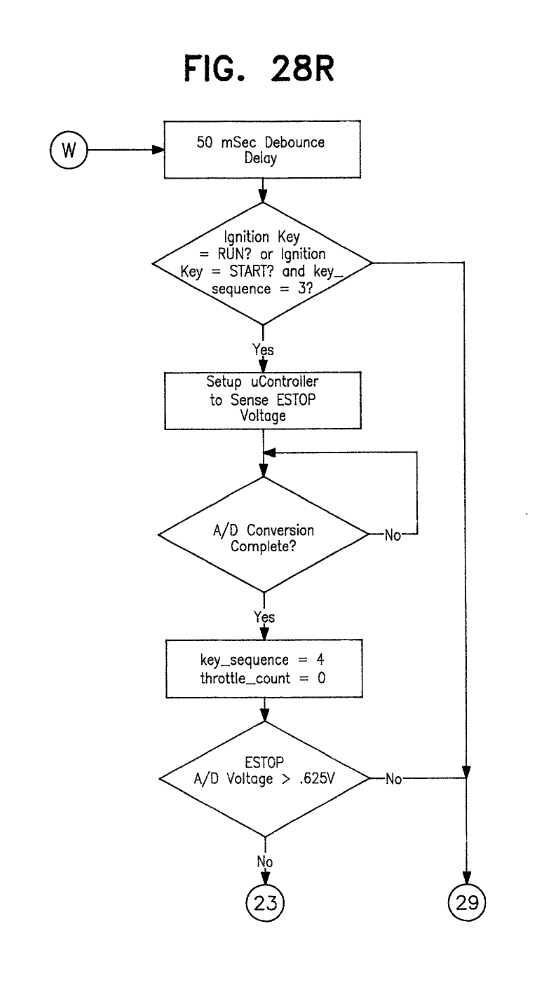

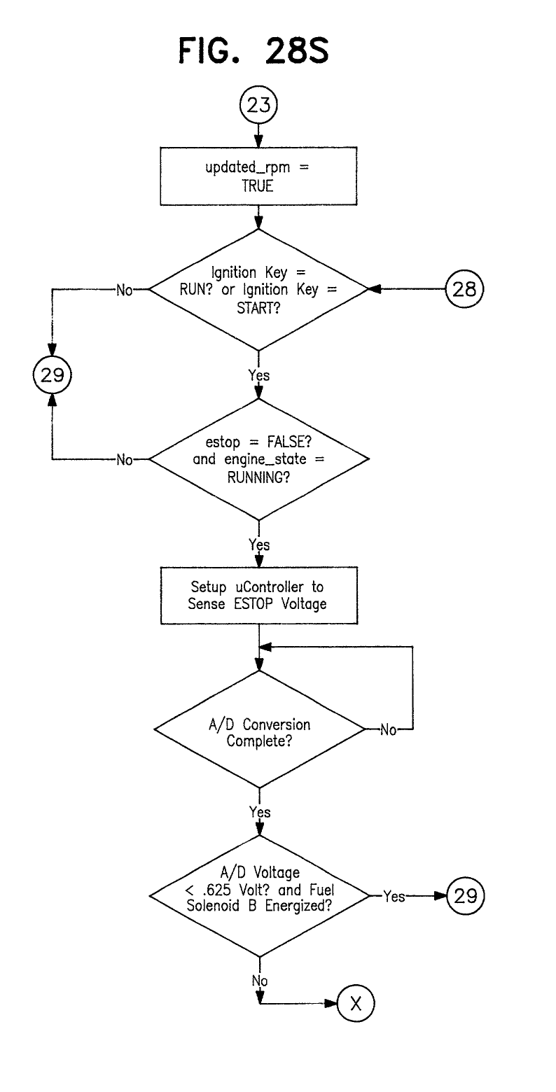

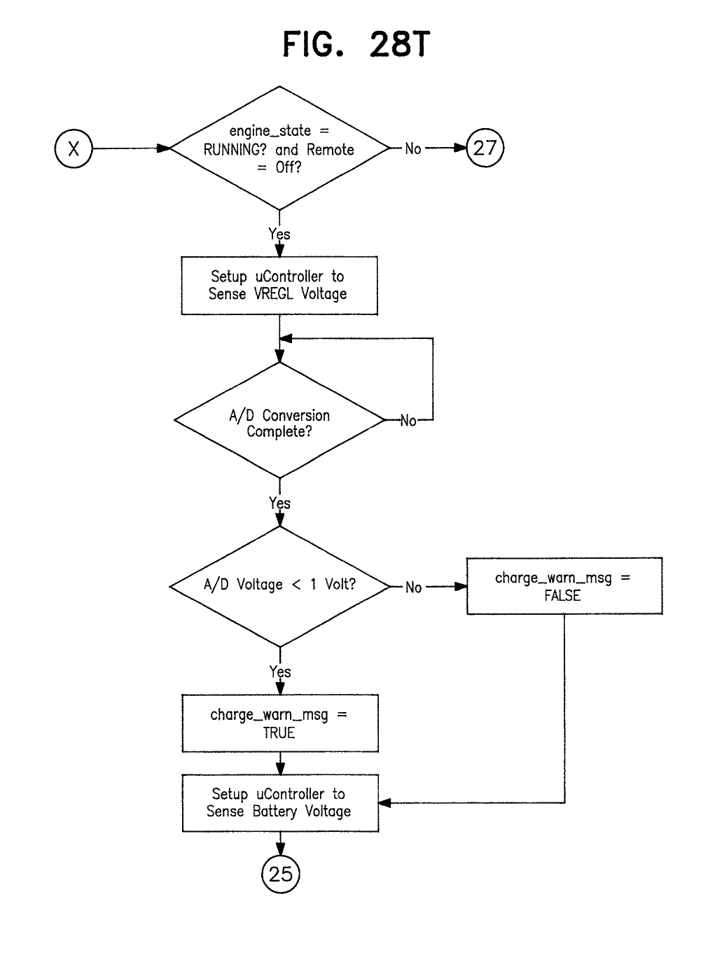

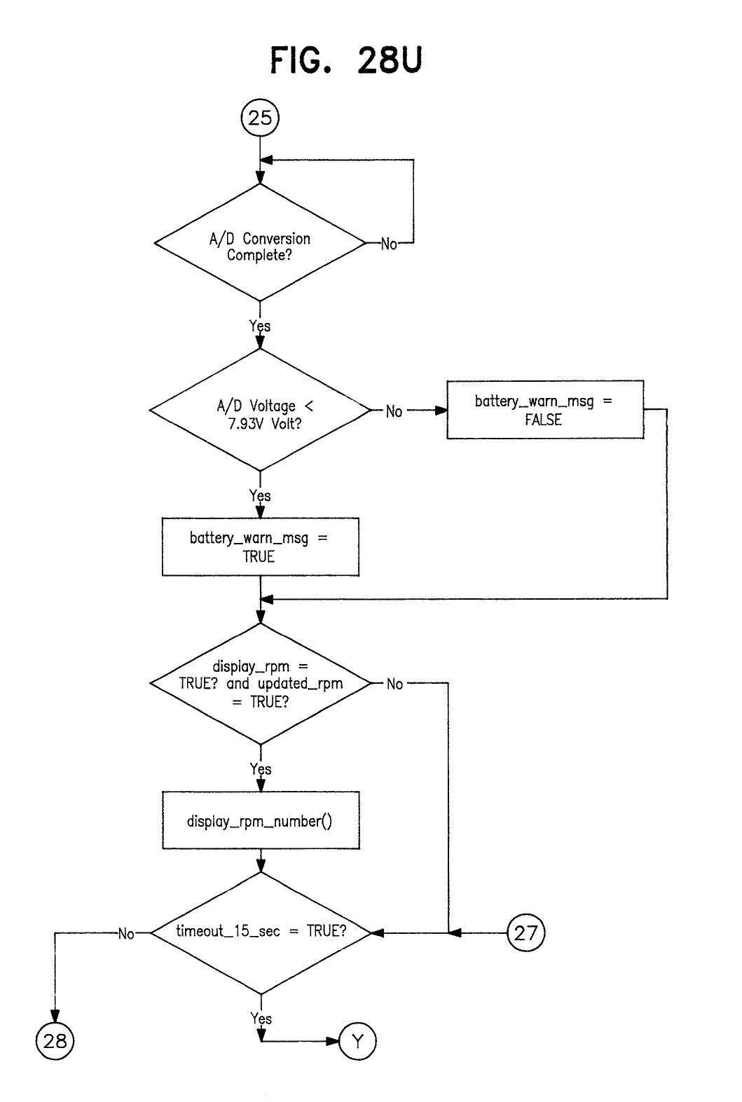

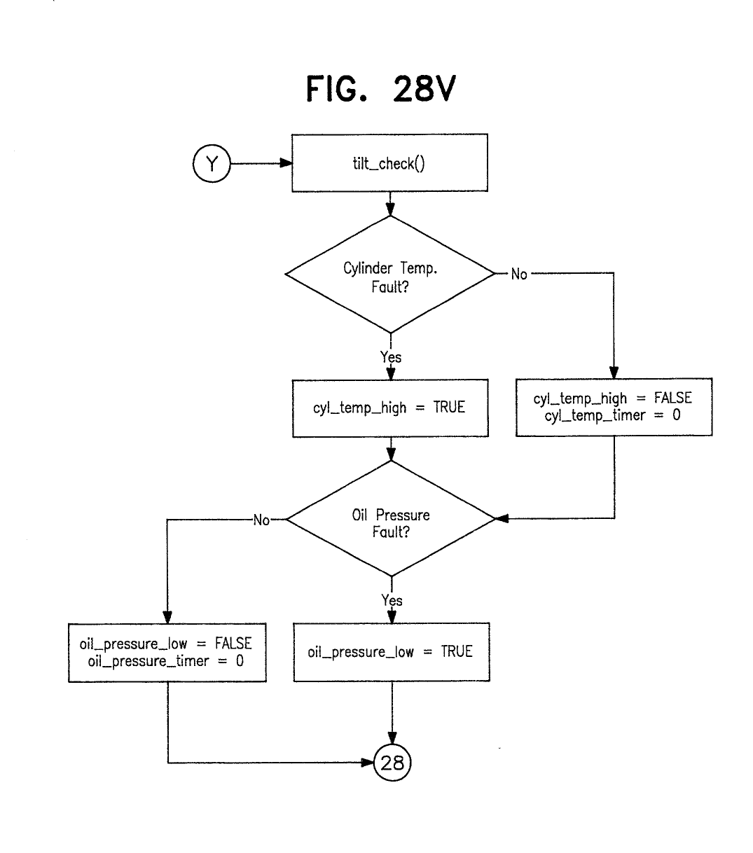

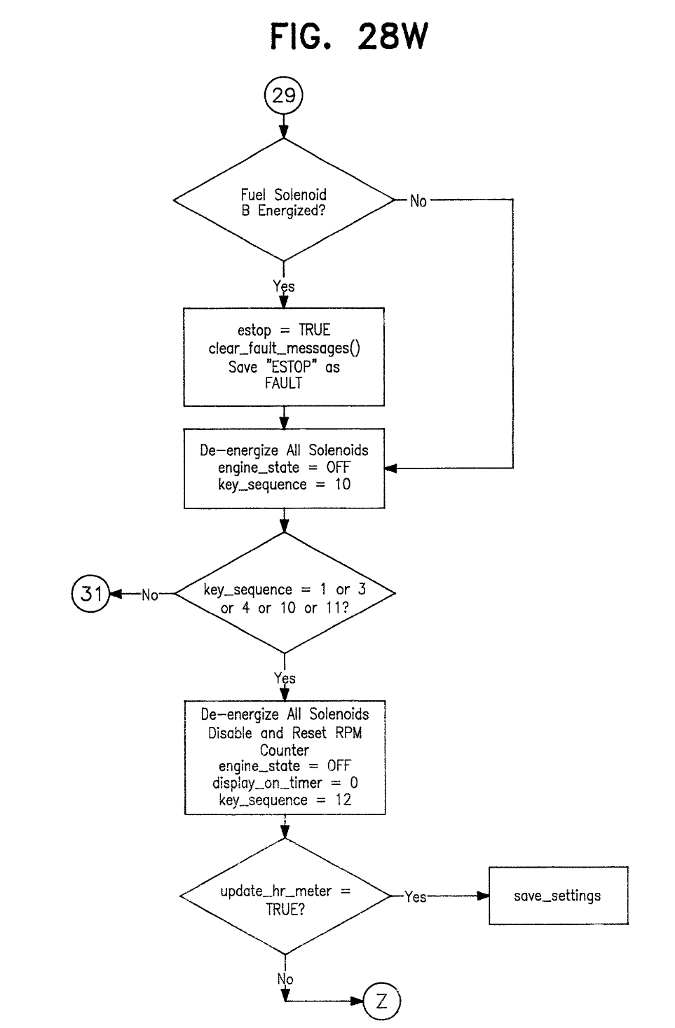

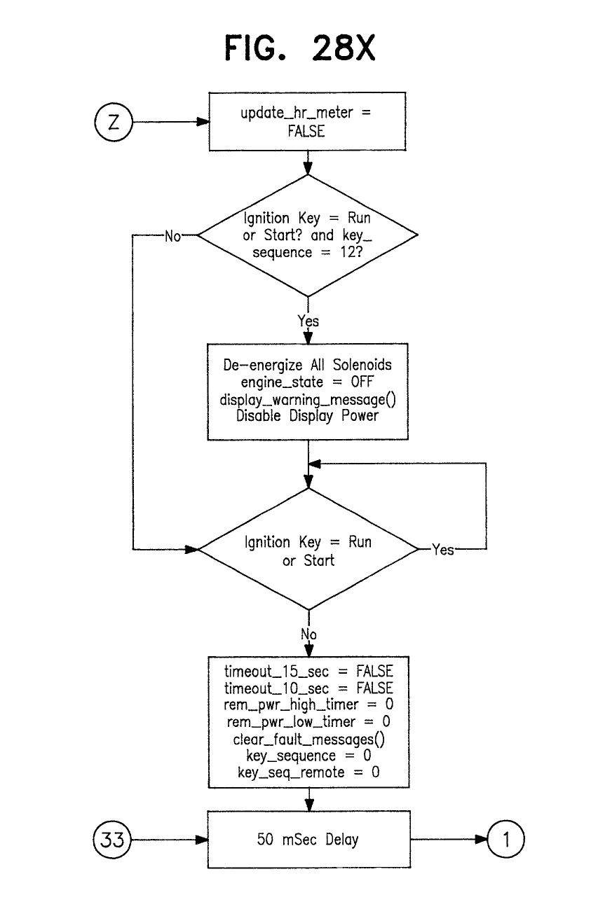

The main program is summarized in the flowchart of FIGS. 28A through 28L. There are three primary loops within the main program, namely remote, accessory switch, and manual mode. The main program continually checks each mode in an endless loop. If conditions for a particular mode are true, the program will execute that mode.

While the encapsulated ECI box 50 with display, and related circuit boards, wiring and microprocessor of the present invention are preferably for a trench roller, the present invention may be used on any type of motorized equipment, including earth moving equipment, backhoes, bull dozers, front loaders, excavators, etc. While many of these devices would not be remotely controlled, all would benefit from the solid-state microprocessor driven circuit board construction which render the ECI box rugged and vibration resistant, enabling reliable display of engine functions and fault indications.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An electronic control ignition (ECI) box for manual and remote control of construction equipment, comprising:
a controller circuit for receiving outputs from a plurality of equipment sensors and for controlling equipment function responsive to said sensor outputs; and
a display circuit for receiving outputs from said controller circuit, said display circuit including a display for presenting equipment operating parameters to an operator;
said controller circuit and said display circuit being embedded in a polymeric material to form a solid unit.

2. The ECI box as set forth in claim 1, said plurality of equipment sensors including an oil pressure sensor, a cylinder temperature sensor, a tilt sensor, an RPM sensor, and an emergency stop sensor.

3. The ECI box as set forth in claim 2, said equipment operating parameters presented to said operator including at least one of an indication of low oil pressure, high cylinder temperature, equipment tip angle in excess of a threshold value, RPM below a minimum speed, and emergency stop condition.

4. The ECI box as set forth in claim 3, further comprising circuitry to automatically shut down an engine of said construction equipment in response to an occurrence of any of said equipment operating parameters.

5. The ECI box as set forth in claim 2, said plurality of sensors further comprising a voltage regulator sensor.

6. The ECI box as set forth in claim 5, said equipment operating parameters presented to said operator including an indication that a battery voltage level is low.

7. The ECI box as set forth in claim 1, said polymeric material including a thermally-conductive epoxy encapsulant with a catalyst demonstrating thermal shock and impact resistance.

8. An electronic control ignition (ECI) box and fault monitoring system for manual and remote control of a motorized construction vehicle having a control panel with engine start, engine run and accessory ignition switch positions, comprising:
a plurality of equipment sensors for monitoring operation of said motorized construction vehicle, said sensors including fault indicating sensors and warning indicating sensors;
a controller circuit for receiving and processing outputs from said fault indicating sensors and said warning indicating sensors;
a display circuit for receiving outputs from said controller circuit, said display circuit including a display for presenting engine operating parameters to an operator, said controller circuit initiating display of engine RPM during normal engine operation in said engine run switch position; and
engine shut-down circuitry, responsive to said controller circuit, for automatically stopping an engine of said construction vehicle in response to receipt by said controller circuit of a fault input from at least one of said fault indicating sensors, said fault input being stored by said controller circuit.

9. The ECI box as set forth in claim 8, said controller circuit and said display circuit being embedded in a polymeric material to form a solid unit that is weatherproof and vibration resistant.

10. The ECI box as set forth in claim 8, said plurality of fault indicating sensors including an oil pressure sensor, a cylinder temperature sensor, a tilt sensor, an RPM sensor, and an emergency stop sensor.

11. The ECI box as set forth in claim 10, said fault input and a respective engine operating parameter presented to said operator including at least one of an indication of low oil pressure, high cylinder temperature, equipment tip angle in excess of a threshold value, RPM below a minimum speed, and emergency stop condition.

12. The ECI box as set forth in claim 11, said controller circuit and said display circuit being embedded in a polymeric material to form a solid unit that is weatherproof and vibration resistant.

13. The ECI box as set forth in claim 8, said plurality of warning indicating sensors including a voltage regulator sensor.

14. The ECI box as set forth in claim 13, said engine operating parameters presented to said operator including a warning message indicating at least one of improper charging and low battery voltage level.

15. The ECI box as set forth in claim 8, said controller circuit initiating display of a last-stored fault input in response to an accessory switch position input from said vehicle.

16. The ECI box as set forth in claim 8, said controller circuit initiating display of a battery voltage level in response to a start engine switch position input from said vehicle.

17. The ECI box as set forth in claim 8, said controller circuit initiating display of a warning message intermittently with display of said engine RPM in response to a run engine switch position input from said vehicle and receipt of a warning input from at least one of said warning indicating sensors.

18. The ECI box as set forth in claim 8, said controller circuit initiating display of a total number of engine operating hours in response to an accessory switch position input from said vehicle.

19. The ECI box as set forth in claim 8, wherein said motorized construction vehicle is a trench roller.

20. The ECI box as set forth in claim 9, said polymeric material including a thermally-conductive epoxy encapsulant.
